(19) United States
(12) Patent Application Publication
(10) Pub. No.: US 2005/0198618 A1
(43) Pub. Date: Sep. 8, 2005

(54) Distributed software fabrication system and process for fabricating business applications

(75) Inventors: Jean-Louis Lalonde, Montreal (CA); Alexandre Boudreault-Ferland, Montreal (CA)

Correspondence Address: FOGG AND ASSOCIATES, LLC, Suite 1000, 10 South Fifth Street, Minneapolis, MN, 55402, US

(73) Assignee: GROUPE AZUR INC.

(21) Appl. No.: 10/792,157

(22) Filed: Mar. 3, 2004

(51) Int. Cl. G06F 9/44

(52) U.S. Cl. 717/110

(57) ABSTRACT

A distributed fabrication system for creating, while promoting strategic alignment between information technology departments and business units' objectives, a business application compatible with XInternet technologies via a communication network. The distributed fabrication system supported by an applicative framework system supplying a generic dynamically adaptable N-Tier client-server object-oriented applicative infrastructure constructed on top of a third party software system infrastructure to support a business application compatible with XInternet technologies via a communication network, the third party software system infrastructure being complemented by database management system components.

### FIELD OF THE INVENTION

The present invention relates to business applications, and more particularly to a distributed software fabrication system and process for fabricating business applications.

### BACKGROUND OF THE INVENTION

In the last 10 years, the evolution of the Internet has forced software to become increasingly complex to be able to harness the web's untapped potential. The process of building and deploying complex systems has made a quantum-leap forward from object-oriented techniques to visual modeling and process automation. However, these innovations have been mostly centered on the information technology (IT) side of the equation. The business side of the equation is still very open for discussion. To achieve the IT strategic alignment with Business Units goals, the pivotal bi-directional communication channel now needs to be addressed:
How can domain expert users be actively involved in ongoing system validation to ensure properly alignment with their business needs?
How can IT quickly and cost-efficiently deliver accurate user-centric system details to ensure high harmonization with business needs?
   To definitively answer these complementary and fundamental questions, one has to create a set of efficient web services that feature a professional e-collaborative environment for IT and business people. These online services must quickly validate and securely transmit IT business analyst software prototypes, business processes, tasks, and rules assumptions via the web.

The IT industry has been setting the boundaries around software development for many IT professionals. But the Internet is tearing down many of these boundaries, paving the way for new opportunities for the emerging e-Software Fabrication Process that allows both IT and business users to better collaborate on projects over the web.

For most companies, developing software is an art form that needs to move closer to an engineering discipline. Moreover, business users are not currently involved enough in a standard Software Development Life Cycle.

With the entrenchment of the World Wide Web in modern society, the business world has experienced its own revolution in terms of how they conduct their affairs. Now that online business is becoming increasingly accepted into mainstream society, the focus has now moved from Business-to-Customer (B2C) interactions to higher-level trade partnerships that need to operate in close cooperation to allow their businesses to grow and succeed.

Essentially, Enterprise Integration (Ei) and Business-to-Business Integration (B2Bi) involve the secured management of business information across a company's internal systems, while synchronizing that information properly with a partner's information systems. Companies, from a broad range of businesses, are taking on B2Bi and recognizing the huge advantages it provides through increase customer and supplier services, lower integration costs, and faster time to market. Moreover, business strategic alignment or the alignment of information systems strategy with business strategy continues to be ranked as one of the most important issues facing corporations.

But how is it possible to securely deploy dynamic e-business applications rapidly at an affordable and competitive price with total user satisfaction? These applications can include the following:
e-Order Processing Systems
e-CRM
e-Partners Management
e-Timesheet Management
e-Incident Management
e-Room Reservation
e-Personnel Assignation
e-Order Scheduling

Ei and B2Bi are best-achieved using web services that promote the reuse of heterogeneous resources disseminated inside and outside of the company's networks. Still, it is very difficult and time consuming to build dynamic e-business applications, consuming web services, with a standard Software Development Process (SDP). Moreover, the cost to develop such high-visibility e-application with a solid foundation and a well-defined XInternet N-Tier applicative infrastructure can easily reach beyond the half a million-dollar mark (assuming that everything goes as planned). Currently, dynamic e-business application development, based on web services, is a booming new trend supported by mainly large and medium-sized corporations using a variety of technologies from a variety of vendors.

E-business applications are becoming more and more complex to build now that the Internet is being transformed towards the XInternet. Project deadlines are being missed, development budgets are being exceeded, and the costs continue to rise.

Many of the currently available development tools possess a complexity designed for developers, architects, analysts, and a few for managers, but none have been designed specifically for business unit people. Throughout a software's life cycle, the level of integration for these tools is very low and must be done manually for the most part.

The problem with many of the development products from many IT tool suppliers on the market is that they are difficult to learn and understand, and even more complex to use. Some companies have managed to enhance their solution using Unified Modeling Language™ (UML™) to simplify their tools with some code generation capability.

The general consensus in development circles is that there needs to be a simplification of the object-oriented software development process. IT experts have discussed the complexity of UML and have made recommendation to simplify it. However, one of the main conclusions is that a process must be used to guide the modeler in order to use UML effectively.

The level of complexity, coupled with the high cost and time required to build dynamic e-application using the standard Software Development Process, prevents most mid size enterprises from building their own applications successfully. Moreover, the quality and performance of resulting in-house e-application is unpredictable, lacking the proper N-Tier applicative infrastructure needed to guarantee application scalability, robustness, and security.

Enterprise integration (Ei) and Business to Business integration (B2Bi) are best achieved when business needs are driving the IT activities. Currently, one important IT activity is to upgrade obsolete desktop applications to the latest version of web-enabled technologies.

Desktop applications are simply programs that are installed and run on a PC. Many of your old desktop applications are built from a variety of generic technologies (such as spreadsheets and database management systems). The industry is currently overflowing with millions of such legacy applications that are reaching the end of their life cycle.

To stay current with ever-evolving business needs, these applications must be quickly recycled to a web-based format, but at a fraction of the previous development cost. Moreover, many corporations are recognizing the need to renew legacy mainframe applications by providing a web interface and to improve interconnections with clients and partners.

Today's users are all too aware of the limitations that shackle their desktop applications, keeping them from providing the much-needed solutions to their business needs. As these applications get older, their speed and power decreases, their instability increases, and the maintenance costs continue to soar, especially when they apply to multiple users across a rising number of workstations. As the number of users continues to grow and as they become more and more efficient at their jobs, they require more and more real-time access to critical business information from the enterprise intranet or via the Internet.

On top of that, the installed technology continues to lag behind needs of its business users. Most business users complain that the level of business integration the applications can provide is not acceptable.

In the past, the only way to take advantage of the whole new world of technology that was out there would be to write the application from scratch. Not only is this approach highly expensive and time consuming, but it would run the high risk of not being able to upgrade the application and have it be compatible with the latest set of technologies.

Today, it is possible to use modern conversion tools to upgrade the power of old applications to be at the same level as the latest set of technology. However, the problem with these tools is that they operate at the code level and were not designed to raise these applications to the web service/N-tier client-server model level, which is better suited to support dynamic e-business applications.

While most desktop applications upgrades target the Enterprise intranet (Ei), some are targeted solely to the Internet (B2Bi). Moreover, some will be deployed on both types of networks, for example: Order Processing at the Intranet level and Order Tracking offered to clients over the Internet.

There are several types of web architectures to which a typical dynamic desktop application can be converted. One of the more common types is a web browser accessing dynamic web pages (using PHP or Active Server Page (ASP)) while connecting to the database frequently with SQL embedded into the page. However, most companies have found that this method is no longer acceptable because of the obvious security breaches. Moreover, the application development, debugging, and maintenance problems associated with hundreds of dynamic web pages are beyond the capabilities of medium to complex business applications development.

Most dynamic web applications have been built on this type of web architecture despite important technical limitations. Although this approach is suitable for low security, general information presentations and small applications, it is not appropriate for modern dynamic e-business applications consuming web services that require high performance and security levels while accessing enterprise databases in real-time.

Some of the limitations of the regular dynamic web page model are as follows:
Low security when not isolated from the database.
Highly instability when multifaceted web applications require many pages with complex workflows.
Difficult to code, debug, maintain, and support.
Difficult to reproduce a desktop application's workflow, its look-and-feel, and its performance.
Business rules are coded directly into the script files.
If poorly designed, the SQL code is located in the script files.

Another important problem is related to the secluded nature of static web sites. Currently, most web sites are not interconnected at the business level and while desktop applications can be upgraded through the web, there are still largely isolated. Although extended networks have increased their speed and capacity, web applications still lack the ability to properly interrelate with each other.

Clearly, to succeed in the field of Ei and B2Bi, there is a need to improve the web infrastructure and eliminate such limitations and answer the following questions:
Why upgrading from a desktop application to a web-based application?
Which application elements must be upgraded?
What is the modern way to upgrade the application?

At the center of an enterprise's preoccupations is the renewal of legacy mainframe and desktop applications while maintaining IT and business units' strategic alignment. IT organizations worldwide use a mix of heterogeneous operating systems (OS/390®, UNIX®, Windows®) to run their most complex applications. The need to protect and extend these systems, while tapping new technology, is central to their future successes.

Being able to make clear case to justify why to convert a desktop application to the web is important. Not all applications need to be converted and some very specific applications that are only used by a few employees are not good candidates.

On the other hand, there are two important types of reasons to convert old and secluded applications to the web:
Business: Pools of users are requesting it since they know that Ei and B2Bi can be best achieved through distributed business processes and securely reachable from the intranet or the Internet.
Technology: Business strategies are best met using modern IT technology strategies, which in turn are highly supportive of business needs.
More than ever before, IT departments are using web-enabled technologies to ensure business processes can interoperate quickly to reach the highest level of Enterprise integration and at the lowest cost possible.

Another trend comes from the fact that desktop applications have been known to inherently grow and become more complex over time. A small application that started as a simple, low scale prototype can grow to become a critical business application supporting tens and sometime hundreds of users.

Even now, hundreds of thousands of enterprises currently have several of these critical applications running on remote client-server platforms. What they desperately need to remain efficient is to scale themselves to the web so that their applications can grow larger and more complex, while still supporting a rising numbers of distributed users.

A typical desktop application runs onto a two-tier client-server with a close tie to the physical implementation. A desktop machine working as a client is physically combined with a network server hosting the business database.

In a traditional client-server model, business rules, or application intelligence, are split between these two complementary poles. Most of the time, around 70% of the business rules reside at the client side frequently refereed as a Fat or Intelligent Client. The client side can be coded in Visual Basic™ or other similar 4GL™. The server side holds the DBMS with contains stored procedures almost always directly bounded to user interface controls.

Desktop applications that are integrated into a similar client-server topology have been plagued with the following limitations:
Difficult to deploy on every workstation and come with very high support and maintenance costs.
Not scalable because the application cannot grow beyond the physical boundaries of a typical two tiers client-server platform.
Not reusable since business rules cannot be encapsulated and centralized onto a single business server.
Poor performance over time because the application grows and becomes more complex, consuming more and more of the limited client workstation processing power and resources.

To better assess the scope of a typical application upgrade to the web, there are several application layers, elements, and components that need to be translated to the newer set of web enabled technologies.

The following is a list of typical software elements to be enhanced, converted, migrated, and aligned to business needs:
1. Software basic infrastructure conversions: from isolated and non-standard technologies to web-enabled technologies supported by standard protocols, data structures, etc.
2. Applicative infrastructure conversions: from a two-tier client-server to N-tier client-server topology supporting a high level of reuse through web services.
3. Application presentation conversions: from a richer client to a somewhat thinner web-based presentation build using secure technologies like HTML, JavaScript, and XML.
4. Application object model, logic, workflow, and business rules conversions and adaptations.
5. Improve the security model.
6. Replace the database security scheme with a distributed security web service and component managing user identification, authorization, and roles.
7. Report conversions.
8. System integration (ERP, CRM, etc.) migrations.
9. May require some database relational model and table, triggers, transactions and stored procedures adaptations and migrations.
10. May require some enhancement to the application to promote business strategic alignment.

There are more conversions and adaptations to make. With so many elements to upgrade, it is difficult to start from scratch with such a huge project. Chances are the application was built and customized over a period of many years.

Depending on the size of the application, it is possible to regenerate the application quickly provided the proper software process and tools to support it are accessible. After this initial phase, standard conversion tools to the best candidate elements to complete the work can be applied.

There are various methods and techniques that can be used to renew the application, but in many cases, these approaches can be combined. A redesign may be better for some structural elements whereas many others might need only language syntax level conversion. There are two main strategies to upgrade client-server application to the web:
Horizontal conversion: one layer of the application is converted into a matching web technologies followed by other layers.
   For example, it is possible to migrate the user interface to HTML and JavaScript code, while the middle tier would be converted in VISUAL BASIC .NET or VISUAL C#™ code (which can be accessed through web services).
   Horizontal migration is ideal in situations where the modules are tightly coupled and the effort and risk involved in the migration is known to a large extent.
Vertical conversion: all the tiers of a software component of a standalone application are migrated to the most appropriate web technologies.
   Vertical migration can be adopted in situations where the components are mostly loosely coupled or the risks and effort involved in a total migration are unclear. By migrating one module, it is possible to get a good idea of the effort required to migrate other modules.
   For example, VISUAL STUDIO.NET™ provides a Visual Basic™ Upgrade Wizard, which performs almost the entire vertical language conversion, barring some modifications that must be made to complete and optimize the upgrade process.

Actually both these strategies can help regenerate the application from a strategic and tactical technique point-of-view.

Redesigning the applicative infrastructure is required to use the new features of the .NET architectural framework (system level). Managed code can easily run and interoperate with unmanaged code (older COM components). Therefore it is possible to reuse many existing components as such.

However, paradigm shifts towards XML web services, Web Forms, and the One Web Page Application call for some horizontal rework in design, coding, and deployment. Standard application conversion tools have inherent limits because they start from the code level instead of the model level.

MODEL DRIVEN ARCHITECTURE has been developed by the Object Management Group to maximize the isolation of business models and requirements from the ever-evolving enterprise underlying information technologies. MDA promotes XML Web services that are based on traceable business requirements, as well as promotes the automatic application code generation onto specific technologies at a given time. MDA eases the upgrade of business applications onto a new set of technologies while promoting the strategic alignment of information systems strategy with business strategy.

An MDA approach is a highly horizontal upgrade process. It can be used to quickly regenerate the application and profit from a new set of technologies.

Thus, with a MDA bridge it is possible to upgrade an application client-server platform and technology based on the latest application business models. As technologies evolve rapidly, the enterprise business models are less subject to drastic and profound changes.

This is the foundation of the MDA approach. Its principle is simple: It develops business application models in terms of a company objectives rather than the technical environment. It consists in creating a PIM (Platform Independent Model) for the company as well as one or more PSMs (Platform Specific Models) in terms of the company's technical environment. The language of model definition is UML, which was adopted as the standard by Object Management Group™ (OMG™) in 1997.

The latest trend that is gaining increasing popularity is the move from the publishing of static pages to Internet networks towards the more dynamic e-business XInternet. The Internet has several limitations that prohibit it to efficiently achieve Ei and B2Bi. Here are some limitations that need to be resolved in order to efficiently upgrade a desktop application to the web.

One critical application layer to upgrade to the web is the application user interface with its underlying software infrastructure. Over the years, people have been somewhat accustomed to the web limitations. They have found a comfort zone for static information publishing. However, for dynamic desktop application upgrade to the web, the transition is not as smooth. This is because desktop applications, accessing corporate databases, are much more complex than regular informational sites. Up to now, web technologies have not adequately matched the level of desktop application natural complexity.

With hundreds of web pages working in conjunction to replicate the client environment, it simply cannot handle complex application workflows efficiently. This approach has proven itself to be highly unstable, and although there are several reductive techniques that can minimize the conflicts, there are still disastrous side effects. For example, complex workflows are often reduced in complexity by forcing users to follow a simpler but somewhat cumbersome irritating web navigation path. This is to avoid managing all possible user generated states and conditions at the client side.

As a result, when a condition occurs that the application cannot handle, the user is forced to restart the web session from the initial entry point.

The following is a list of some additional limitations associated to standard web architecture compared to its desktop counterpart:
Web client controls are not as rich
The application's look-and-feel is distorted and deformed
Performance and robustness is noticeably lacking
Reliable security is more difficult to achieve

Another important problem is related to the secluded nature of static web sites. Currently, most web sites are not interconnected at the business level. Desktop applications upgraded to the web are almost as isolated as they were when they existed solely on the workstation. Although extended networks have improved in speed, web applications still lack the ability to properly interrelate with each other.

But thanks to the new paradigm shift toward the XInternet, web applications can regain the same power and performance as regular desktop applications. Moreover, with Web services at the central part, it enables cheaper, shareable, and flexible links to customers and partners.

The XInternet is currently replacing today's static web pages with more dynamic techniques, as well as replacing the fragmented IT infrastructure inside companies with interconnected processes over extended networks.

Web services provide a standard means of interoperating between different software applications running on a variety of platforms. Web Services use SOAP (Simple Object Access Protocol) to communicate with XML-based messages to achieve dynamic integration between two applications. Web Services have been designed to promote the dynamic Ei and B2Bi.

Several enterprises are currently integrating Web Services into their Enterprise Integration/Business to Business Integration (EI/B2Bi) strategy. Web Services technology can add value in the following ways:
Web Services have a low barrier to entry for development teams.
Web Services are independent of operating systems and language.
Web Services are based on standards that will likely be implemented by most companies to support their supply chain.

The limited effectiveness of two-tier client-server model in a highly distributed environment has brought to us the new and improved N-tier client-server model. This enhanced client-server model is based on the ability to construct partitioned applications, which in turn can be easily reachable form the web.

Partitioning an application breaks up your code into logical components disseminated on business and web servers. Components can be logically grouped into three tiers:
User services;
Business services; and
Data services

Once an application has been constructed using this model and its supporting applicative infrastructure, each component can be deployed to any machine which will provide the highest level scalability, security, robustness, and performance. There are essentially four benefits to N-tier client-server architecture model:
Performance: Given time, any desktop application will outgrow its desktop machine. But thanks to N-tier client/server model, application components can be deployed to more than just client workstations.
The ability to shift processing load from a client machine (that may be underpowered) to a server with extra computer processing power and memory is provided, thus significantly enhancing the user experience without any application code optimization.
Reuse: Since business and system components can be centralized onto a few servers, any application being built can reuse their distributed services. A component is built once and is reused constantly in current and future development.
Manageability: Large software programs (.exe) are divided into a set of more manageable components.
Maintenance: Centralized components are much easier to upgrade and deploy when a modification is made. Also, a browser application costs much less to maintain.

Before it is possible to upgrade a regular client-server application to the web, there are several important design issues that need to be taken into consideration. Ideally, an application with an N-tier client/server infrastructure is design from the very beginning.

This is exactly how a MDA approach can quickly convert a regular client-server application to a web-enabled N-tier client-server applicative infrastructure. The power of the .NET architecture lies in its Managed Code feature, which adds to the robustness of Java applications, especially when compared to the previous generations of Microsoft™ software. VB™.NET™ code targets the Common Language Runtime (CLR) by compiling into an intermediate language, which is then executed under strict control (managed). CLR manages the code in a very similar fashion to the Java model, thereby making applications much more Robust, Stable and secure. The application also becomes more maintainable because of the managed code.

XML Web Services creation and integration as facilitated by the .NET platform are readily available through VB.NET. This makes the creation of hosted applications easier, thereby providing wider access to proprietary intellectual property. XML and web services also enable Enterprise Application Integration through standard methodologies as available through the MICROSOFT family of .NET servers.

Known in the art are U.S. Pat. No. 6,161,211 (Southgate), U.S. Pat. No. 6,192,394 (Gutfreund et al.), U.S. Pat. No. 6,304,861 (Ferguson), U.S. Pat. No. 6,519,763 (Kaufer et al.), U.S. Pat. No. 6,658,642 (Megiddo et al.), and U.S. patent application Nos. 2002/0046281 (Cope), 2002/0059054 (Bade et al.), 2002/0066074 (Jabri), 2002/0077823 (Fox et al.), 2002/0091988 (Murphy), 2002/0107994 (Richards, III et al.), 2003/0009740 (Lan), 2003/0018951 (Srivastava et al.), 2003/0023679 (Johnson et al.), 2003/0028579 (Kulkarni et al.), 2003/0028608 (Patterson), 2003/0033586 (Lawler), 2003/0045950 (Bronikowski et al.), 2003/0065413 (Liteplo et al.), 2003/0145306 (Melahn et al.), 2003/0172367 (Kannenberg), 2003/0192029 (Hughes), 2003/0208459 (Shea et al.), which show examples of systems and methods for collaboration between programmers and business users to fabricate applications from business rules.

### SUMMARY OF THE INVENTION

According to the present invention, there is provided a distributed fabrication system for creating, while promoting strategic alignment between information technology departments and business units' objectives, a business application compatible with XInternet technologies via a communication network, the fabrication system comprising:
a client workstation connectable to the communication network, the workstation having a-browser interface;
a software factory displayed in the browser interface through which a user fabricates the business application in response to business need specifications, the software factory being displayed in the browser interface from factory building files, the software factory comprising:
a first tool for defining a solution containing the business application, the first tool comprising components for entering solution parameters;
a second tool for constructing the solution using business models in relation with the solution parameters, the second tool comprising components for designing basic characteristics of the solution and a business domain model of the business application having a main entity and related entities, the main entity establishing relationships with the related entities, the main entity and the related entities having attributes and actions, the second tool also comprising components for designing a menu of the business application, specific functions of the business application, and functional descriptions of the business application;
a third tool for validating the solution, the third tool comprising components for previewing the solution by automatically generating a working prototype of the business application using dynamic database simulation means for testing the working prototype of the business application and communication components for feedback messages between users testing the working prototype of the business application and users constructing the solution; and
a fourth tool for generating code forming an initial and operational version of the business application to be supplied as a normalized input to a regular desktop development system; and
a web server connectable to the communication network, the web server providing the factory building files and controlling the software factory displayed in the browser interface of the workstation.

Preferably, the first, the second, the third and the fourth tools of the software factory use a business model to assist with creation of the business application to isolate business application definitions from implementation of the business application on any specific technology platform.

Preferably, the first tool further comprises importing means for importing a business object and data model for constructing the solution and to design the basic characteristics of the solution, the application business domain model, the application specific functions, and the application functional descriptions.

Preferably, the code forming the business application comprise an applicative framework supplying a generic dynamically adaptable N-Tier client-server object-oriented applicative infrastructure constructed on top of a third party software system infrastructure to support the business application, the third party software system infrastructure being -complemented by database management system components.

Preferably, the applicative framework comprises generic adaptable software structures for the creation of the business application on any specific technology platform using a web server, a business server and a database server on which the business application is fabricated, developed, tested and deployed, the applicative framework also comprising:
user services for managing a business application user interface, relying on a XInternet one web page application pattern, on a workstation having a browser interface to access the business application from the web server on which business application web services are deployed, the business application user interface being a dynamic web page avoiding web page transitions for user experience, the user services comprising one web page application components library for displaying the business application user interface on said browser interface and for communicating between the business application user interface displayed in said browser interface and the business application web services deployed on the web server, the one web page application components library providing bi-directional communications between said workstation and said web server;
business services for managing business application logic and communications between the business application web services, the applicative framework and the third party software system infrastructure, the business services being implemented on the business server, the business services comprising generic adaptable components having interface application components, core application components, utility application components and task application components, the generic components being used to insure code reusability, adaptability, uniformity, isolation, stability, robustness, scalability and performance; and
data services for managing business application data access logic and communications between the business services and the third party database management system components on the database server upon request of the business server on which the business services are implemented, the data services comprising generic adaptable database access components having database scripts to automatically assist the creation of application database tables and stored procedures required to access and manage application data on the database server.

Preferably, the code generated by the fourth tool comprise an approved, operational and well-formed solution comprising the applicative framework specified from business application definitions to be supplied as a normalized input to a regular desktop development system.

Preferably, the first tool also comprises security components to define security for business users and information technology experts access rights and roles to the solution.

Preferably, the second tool comprises web services to define and connect application domain entities and the third tool comprises web services to preview, test, validate and interact with application domain objects and object links.

Preferably, the dynamic database simulation means for testing the working prototype of the business application comprise an XML document simulating an application database, the XML document being used to add, delete and modify the application domain objects and object links.

Preferably, the database simulation means for testing the working prototype of the business application comprise object operation means for adding objects in a simulated database, modifying the objects in the simulated database, deleting the objects from the simulated database and finding, adding, modifying and deleting links between the objects, the object operation means being used for testing the main entity objects of the application, the related-entities objects of the application, the menu of the application, the specific functions of the application and the functional descriptions of the application.

Preferably, the distributed fabrication system further comprises a database server connectable to the communication network. The communication components for feedback messages between the users testing the working prototype of the business application and the user constructing the solution comprise collaborative functions means for providing a collaboration center with the feedback messages centralized on the database server.

Preferably, the factory building files are selected from a group consisting of HTML files, ASPx files, DHTML components files, programs files, assemblies files, components files, XML Documents files and Web Services files accessed from HTTP,S and SOAP protocols.

Preferably, the third tool further comprises components for automatically generating a functional document of the solution.

Preferably, the solution comprises a plurality of the business application.

Preferably, the testing of the working prototype of the business application allows to determine a state of operability and profitability of the solution by following a project go/no go type workflow to reduce cost and time for project approval.

According to the present invention, there is also provided an applicative framework system supplying a generic dynamically adaptable N-Tier client-server object-oriented applicative infrastructure constructed on top of a third party software system infrastructure to support a business application compatible with XInternet technologies via a communication network, the third party software system infrastructure being complemented by a database management system components, the applicative framework system comprising:
a client workstation connectable to the communication network, the workstation having a browser interface;
a web server connectable to the communication network;
a business server connectable to the communication network;
a database server connectable to the communication network; and
an applicative framework comprising generic adaptable software structures for the creation of the business application on any specific technology platform using the web server, the business server and the database server on which the business application is fabricated, developed, tested and deployed, the applicative framework also comprising:
user services for managing a business application user interface, relying on a XInternet one web page application pattern, on a workstation having a browser interface to access the business application from the web server on which business application web services are deployed, the business application user interface being a dynamic web page avoiding web page transitions for user experience, the user services comprising one web page application components library for displaying the business application user interface on said browser interface and for communicating between the business application user interface displayed in said browser interface and the business application web services deployed on the web server, the one web page application components library providing bi-directional communications between said workstation and said web server;
business services for managing business application logic and communications between the business application web services, the business services being implemented on the business server, the applicative framework and system components of the third party software system infrastructure, the business services comprising generic adaptable components having interface application components, core application components, utility application components and task application components being used to insure code reusability, adaptability, uniformity, isolation, stability, robustness, scalability and performance; and
data services for managing business application data access logic and communications between the business services and the third party database management system components on the database server upon request of the business server on which the business services are implemented, the data services comprising generic adaptable database access components having database scripts to automatically assist the creation of application database tables and stored procedures required to access and manage application data on the database server.

Preferably, the third party software system infrastructure comprises a MICROSOFT .NET framework and COM+ service components.

Preferably, the interface application components comprise function means for performing the following operations to help create a normalized data model:
creating, inserting, updating and deleting main objects;
creating, inserting, updating and deleting main object related objects;
creating, inserting, updating and deleting main object links to the related objects;
finding a list of the main objects;
selecting in the list one of the main objects;
creating, inserting, updating and deleting main object operations;
creating, inserting, updating and deleting main object related object operations;
creating, inserting, updating and deleting object de-normalized views; and
creating, inserting, updating and deleting application menus.

Preferably, the core application components comprise function means for performing the following operations:
managing business application workflow and handling business application architectural aspects, the architectural aspects transaction management, error management and diagnostic management;
implementing business application tasks and rules;
managing data services workflow and handling specific database transactions; and
implementing database connections.

Preferably, the utility application components comprise an exception manager to manage warnings and errors, a diagnostic manager to diagnose the business application and to recover from errors, an email manager to handle electronic communications, a report manager to produce reports, configuration files to replace old registry settings, and common functions means to provide basic reusable functions.

Preferably, the task application components comprise a security manager to manage access rights validations to the business application and a reference data manager supporting generic or specific reference table data models.

According to still another object of the present invention, there is also provided a distributed software fabrication process for creating, while promoting strategic alignment between information technologies departments and business units objectives, a business application compatible with XInternet technologies via a communication network, the software fabrication process comprising the steps of:
displaying a software factory through a browser interface of a client workstation connectable to the communication network, the software factory allowing a user to fabricate the business application in response to business need specifications, the software factory being displayed in the browser interface from factory building files;
providing the factory building files from a web server to the client workstation and controlling the software factory displayed in the browser interface of the client workstation;
defining a solution containing the business application via the software factory, the software factory comprising a first tool having components for entering solution parameters;
constructing the solution using business models in relation with the solution parameters via the software factory, the software factory comprising a second tool having components for designing basic characteristics of the solution and a business domain model of the business application having a main entity and related entities, the main entity establishing relationships with the related entities, the main entity and the related entities having attributes and actions, the second tool also comprising components for designing a menu of the business application, specific functions of the business application, and functional descriptions of the business application;
validating the solution via the software factory, the software factory comprising a third tool having components for previewing the solution by automatically generating a working prototype of the business application using dynamic database simulation means for testing the working prototype of the business application and communication components for feedback messages between users testing the working prototype of the business application and users constructing the solution;
determining a state of operability and profitability of the solution by following a project go/no go type workflow to reduce cost and time for project definition and approval and to improve strategic alignment between information technologies and business units objectives; and
generating code via the software factory to form an initial and operational version of the business application to be supplied as a normalized input to a regular desktop development system, the code forming the business application comprising an applicative framework supplying a generic dynamically adaptable N-Tier client-server object-oriented applicative infrastructure constructed on top of a third party software system infrastructure to support the business application on any specific technology platform.

The present invention delivers a solid foundation for improving Business User involvement, along with the software factory, a web application that offers an innovative set of web services designed for Ei and B2Bi via a web-based Software Fabrication Process (e-SFP), which can be used in any place, using any path, at any pace, and at any time.

The software factory empowers IT and Business people with a highly e-collaborative workflow to quickly create, reuse and automatically transform business models into easy-to-understand e-business application prototypes, which Business Users can then rapidly test, validate, rectify, and approve over a secured web site.

At the end of the analysis phase a working and well-formed VISUAL STUDIO.NET solution can be generated for the developers to download, use and complete within a standard desktop Software Development Process.

### BRIEF DESCRIPTION OF THE DRAWINGS

A detailed description of preferred embodiments will be given herein below with reference to the following drawings, in which like numbers refer to like elements:

FIG. 1 is a schematic representation of a solution for fabricating business applications by using integrated software components according to the present invention.

FIG. 2 is a schematic representation of a collaboration workflow showing interactions between different contributors to a project using a software fabrication process according to the present invention.

FIG. 3 is a schematic representation of a user interface of a software factory according to the present invention, showing a logon page.

FIG. 4 is a schematic representation of the user interface of the software factory, showing a first tool used to define the solution.

FIG. 5 is a schematic representation of the user interface of the software factory, showing list of solutions available.

FIG. 6 is a schematic representation of the user interface of the software factory, showing the first tool used to manage solution permissions.

FIG. 7 is a schematic representation of the user interface of the software factory, showing a second tool used to construct the solution.

FIG. 8 is a schematic representation of the user interface of the software factory, showing a task list.

FIG. 9 is a schematic representation of the user interface of the software factory, showing a project plan summary.

FIG. 10 is a schematic representation of the user interface of the software factory, showing a third tool used to validate the solution.

FIG. 11 is a schematic representation of the user interface of the software factory, showing a working prototype of the business application.

FIG. 12 is a schematic representation of the user interface of the software factory, showing a preview of a functional document of the business application.

FIG. 13 is a schematic representation of the user interface of the software factory, showing a fourth tool used to generate the solution.

FIG. 14 is a schematic representation of N-tier system topology according to the present invention.

FIG. 15 is a schematic representation of user services according to the present invention.

FIG. 16 is a schematic representation of N-tier system topology security system according to the present invention.

FIG. 17 is a schematic representation of business services according to the present invention.

FIG. 18 is a schematic representation of data services according to the present invention.

FIG. 19 is a schematic representation of the framework system high level component according to the present invention.

FIG. 20 is a sequence diagram of the one web page application startup according to the present invention.

FIG. 21 is a sequence diagram showing the interactions between the framework and the application structures to make the Find Business Object call according to the present invention.

FIG. 22 is a sequence diagram showing the interactions between the framework and the application structures to make the Insert Business Object call according to the present invention.

FIG. 23 is a schematic representation of a strategic alignment of IT strategy and business strategy according to the present invention.

### DETAILED DESCRIPTION OF A PREFERRED EMBODIMENT

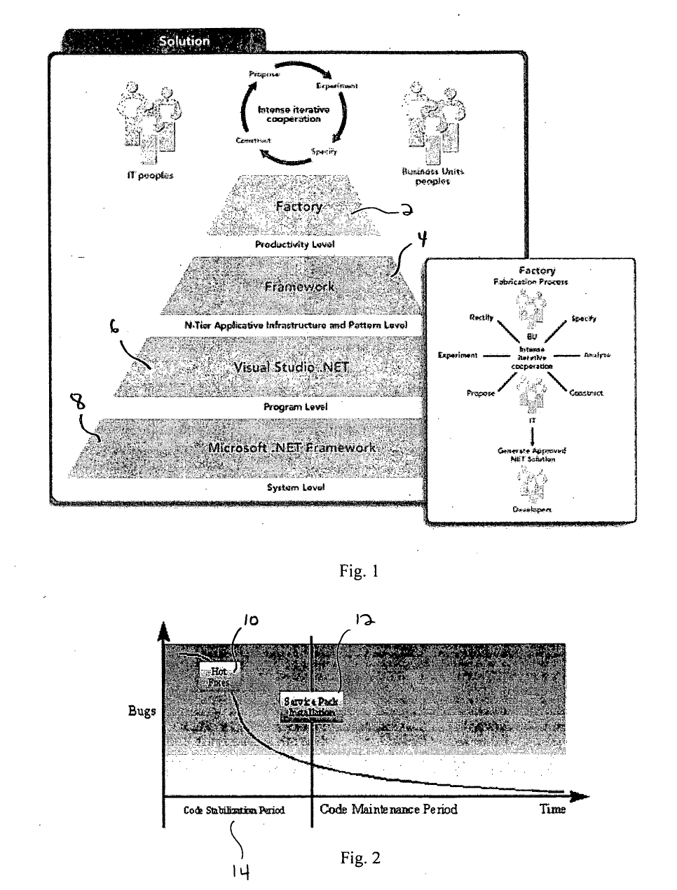

Referring to FIG. 1, there is shown a schematic representation of a solution provided by a suite of XInternet applications fabrication and infrastructure software that enable IT people to analyze, construct, generate, integrate and manage business or e-business applications. As shown, the structure of the solution can be the following:
The software factory 2 (Productivity and Collaborative Level)
The applicative framework 4 (N-Tier Applicative Infrastructure and Pattern Level)
VS .NET 6 (Program Level)
MICROSOFT .NET framework 8 (System Level)
   Software Fabrication Process (SFP)

The solution is backed by a Software Fabrication Process (SFP) with productivity tools. SFP speeds up and supports the automated fabrication of e-business applications while reducing both the time and cost required to complete these projects.

SFP hides most of the complexity until it is time to customize the software with the specific structures, business rules, and process integrations. SFP solution allows the business and IT people to be truly and efficiently involved at the center of the analysis phase to ensure strategic alignment.

The SFP is meant to complement the usual Software Development Process (SDP), but both processes are used to quickly and efficiently produce e-business applications.
SFP: this strategic process automatically generates the dynamic e-business application generic structures based on business models and requirements.
SDP: this tactical process manually codes the business specific structures and matching business rules.

UML makes communication easier between UML trained IT people. However, UML standard system representations are much to complex to be systematically and successfully presented to business users for system validation and rectification.

Phase 1—Project Specifications

This phase aims to clarify the scope of the project. From the specifications supplied by the customer, the IT analyst uses the software factory 2 to easily fabricate and validate the web application prototypes with associated project functional descriptions. Usually a project is composed of several XInternet e-business applications working together to produce an enterprise system for financial, production or other business processes or functions.

Rapid Prototyping: With the software factory 2, it is possible to construct rapidly Web prototypes of the projected applications in order to convince and secure decision-makers and users. Analysts and end users can organize meetings to present the project for those who will take an active part in the project.

Deliverables: A Specification Document, including application prototypes with high level functional descriptions, main use cases, report specification, off line process specification, system integration specifications, logical data model (LDM) and a high level project plan with good cost estimates.

Phase 2—Application Definitions

This phase consists in detailing each element discussed during phase 1 and to precise business rules within a Functional Document. The IT analyst uses the software factory 2 to refine and fabricate the web applications. Client's business analysts meet the IT analysts in order to produce and refine the functional documents for each e-business application.

Deliverables: A Functional Document signed and approved by the client, including the first version of the application .NET solution with descriptions and business rules, detailed use cases, report definitions, system integration definitions, off line process definitions, application security, functional tests and a detailed project plan with precise cost estimates.

Phase 3—Design Definitions

The framework 4 provides built in several useful design patterns implemented in its reusable generic components. Specific business application designs can be produced by IT peoples from standard UML design tools such as Class and Object diagrams, Interaction diagrams and Use cases all included in the Modeller tools like IBM Rational Rose™ and Borland Together™ tools.

Physical Data Model (PDM) of the relational database is produced from the LDM as phase 3 evolves. The system architect and main software analyst always review thoroughly these documents.

Deliverables: Design Documents for specific user functions.

Phase 4—Application Coding

IT analysts use the software factory 2 to easily generate the first version of the application code for all level of services including the user interface, the Web services, the business services and database services. The framework 4 is thus automatically included in the resulting developer .NET solution. The developers then complete the application code in its regular VISUAL STUDIO.NET IDE accordingly to the following inputs:
Application generated code
Functional Document
Design Documents

The developer does unit tests on his code and code reviews are done periodically Deliverable: Stable and operational application code.

Phase 5—System Integration Tests

Integration tests of the solution in the integration test environment. The application code needs to be tested into the whole system being fabricated. The application is integrated in an adequate representation of its future production environment.

Deliverable: Application integrated into the new system.

Phase 6—Users Acceptance Tests

User acceptation tests of the solution in the acceptation test environment. The application code needs to be tested into the whole system by the super users for final approval. The application is validated in an adequate representation of its future production environment.

Deliverable: User approved application integrated into the new enterprise system.

Phase 7—Corrections and Application's Finals Adjustments

Accordingly to a Request of Change procedure, developers realize the modifications users asked for. Delivery schedule and costs needs to be updated as a result.

Phase 8—Production of a User Guide Manual

Provide an application user guide, which accelerates the learning curve of the users.

Phase 9—Training

Provide training for all end users, which accelerate the learning curve of the users.

Phase 10—Application Installation in the Client's Production Environment

Provide a deployment mechanism into the production environment. Application deployment under .NET can be efficiently done with the Install Shield Software™. The users start using the system applications.

Phase 11—Code Stabilization

Referring to FIG. 2, users report bugs when the application is in production mode. The IT development teams do hot fixes 10 and service pack 12 production. This code stabilization 14 usually takes 1 to 2 months after the code is in production as shown in the next figure.

Phase 12—Maintenance

The IT peoples maintain the application code.

Unlike existing in-house desktop approaches, typical out sourced solutions or off the shelf solutions, the solution of the present invention enables IT and Business people to better collaborate over the web to quickly create low cost, robust and stable XInternet applications that deploy quickly, refresh almost instantly, and maximize user experience.

The solution makes available to enterprises a crystalline malleable technological response to web business application fabrication. The solution focuses on the following:
The Software Fabrication process (SFP) providing a rigorous analytical and development method for developing reliable web applications within a limited amount of time and budget;
The software factory 2 providing a very efficient and visual Web tool to optimize project specification and analysis phases and afterward to rapidly and automatically generate well-formed .NET operational Web applications to maximize developers efficiency;
The framework 4 providing a highly flexible .NET N-level client-server applicative infrastructure, which can respond to client needs with respect to collecting, processing, integrating and sharing data on extended networks. It also provide a richer and faster web interface dedicated to business applications, XInternet compatible, and supply a software platform that gives web applications the power and performance of desktop applications as illustrated by the One Web Page Application (OWPA) concept;
A Support Center providing the transfer of technological knowledge to ensure the client is fully autonomous with the solution at the end of the deployment.

The software factory 2 provides an innovative Web tool, allowing intense interactive cooperation between the Business units (BU) and Information technology (IT) professionals during specification and analysis phases. The development process has been built around a unique One Web Page Application Pattern, which is XInternet compatible. Once the One Web Page Application Prototype is approved by all IT and BU users, the factory tool enables IT individuals to generate a complete operational One Web Page Application, which is complemented by the framework 4, allowing developers to complete the application with the MICROSOFT .NET development tool (VISUAL STUDIO .NET). Moreover, the factory is MDA compatible. Therefore, it can easily translate a predefined UML model into a complete .NET OWPA within seconds with its code generation capability.

The framework 4 provides a solution for rapid project startup and efficient development of complex Web transactional and operational applications. These applications are complex to create. They require a very high level of skill and expertise. Moreover, a company that wants to build its own N-Tier architecture would need to invest in a sustained R&D effort for a minimum of one year with an experienced team. Often, for a small or medium sized company, developing customized N-Tier framework is not financially and technologically accessible. At the end of the analysis phase, the framework 4 is automatically incorporated in the client's .NET solution by the factory's enabling application generator. This represents a very important productivity boost.

The framework 4 has been upgraded to MICROSOFT .NET technologies to supply an efficient fabrication solution for the emerging XML Web Services applications and system integrations. MICROSOFT .NET framework gives the indispensable building blocks reused for each of N-Tier architecture components and system integrations of the present invention.

The framework 4 includes several major designs patterns driven by the One Web Page Application (OWPA) model, a stable and widely accepted approach in developing efficient Web business applications. These structural patterns enable clients to build their systems with predefined structures. The framework 4 thus represents a fundamental and strategic achievement for building high quality complex systems from reusable generic structures. This allows much faster system development and saves a great deal of time and money.

The One Web Page Application is thus an important aspect of the framework 4. This interface is user friendly and gives Web applications the power, look and feel and performance of regular desktop applications. Dynamic e-business applications deployed in browsers could not be made of static Web pages alone. OWPA JavaScript components library better harness the user workstation processing power. These dynamic components communicate powerfully with Web Services through SOAP calls handling small XML documents, the application data, without ever refreshing the main Web page. The result is XInternet friendly.

Once the One Web Page interface is approved by all IT and BU users, IT developers can quickly construct a complete operational One Web Page Application within the MICROSOFT VISUAL STUDIO .NET development tool.

The software factory 2 is a Web factory that allows an organization to acquire a new capacity for distributed analysis that optimizes cooperation between IT experts and business unit personnel.

With the software factory 2, IT experts will build new-generation business applications and put them up, when the time is right, on a work Web site accessible through the company's network. The business experts can then access the Web version of these applications whenever they choose, to experiment, verify and rectify the analysts' work.

This user-friendly building process is optimized around a very visual Web projection that supports the following fundamental activities:
IT experts use the software factory 2 to build and introduce the e-business interface, including functional descriptions, to expert users;
Expert users use the software factory 2 to test the e-business interface, correct and refine the specifications.
   The Collaboration Workflow

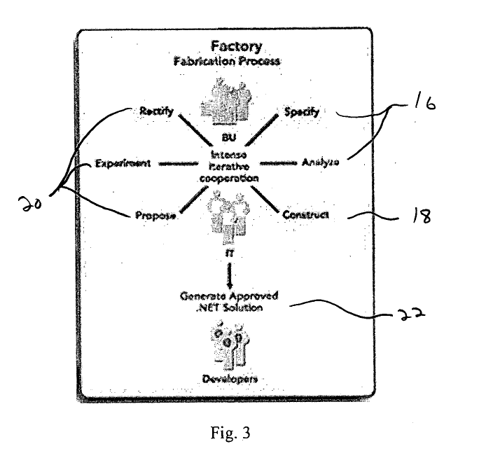

Referring to FIG. 3, to execute the SFP and promote strategic alignment, there is shown a collaboration workflow supporting an online software fabrication process and producing a dynamic e-business application in four easy steps:
1. Define the solution 16
   a. Define solution parameters;
   b. Import the UML model (optional);
   c. Define the security for IT and expert users access rights and roles;
2. Construct the solution 18
   a. Define and refine the business models and rules;
3. Validate the solution 20
   a. Generate automatically the client side of the e-application;
   b. Experiment the application with an XML database simulation;
   c. Generate automatically the functional document;
   d. Provide user feedback into a web analysis log;
4. Generate an approved and operational .NET solution 22

After analyzing the business needs, the IT experts can automatically generate an approved .NET solution that developers can finalize and deploy in the approval and production environments.

The software factory 2 implements the Software Fabrication Process to help people build One Web Page Applications (OWPA) in four easy steps:
Define the solution;
Construct the solution;
Validate the solution;
Generate an approved .NET solution.
   Distributed Fabrication System

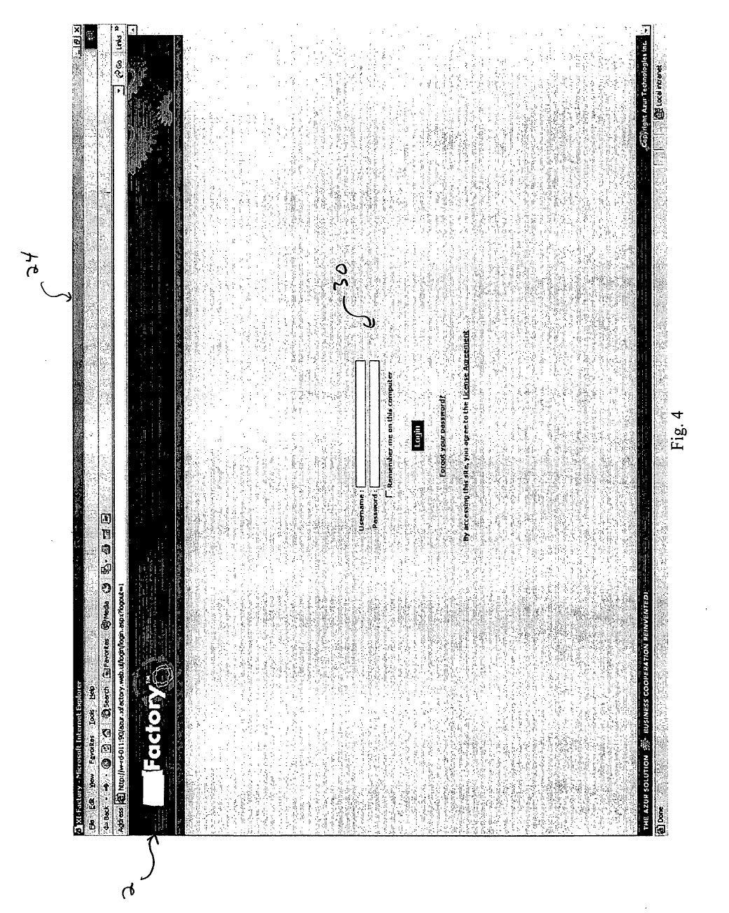

The solution comprises a distributed fabrication system for creating, while promoting strategic alignment between information technology departments and business units' objectives, a business application compatible with XInternet technologies via a communication network. The fabrication system has the software factory 2 displayed in a browser interface 24 (or container/controller or other similar interface) (as shown in FIG. 4) of a client workstation connectable to the communication network, through which a user fabricates a business application in response to business need specifications. The software factory 2 is displayed in the browser interface from factory building files provided by a web server connectable to the communication network. The web server also controls the software factory displayed in the browser interface of the workstation.

The software factory 2 has a first tool for defining a solution containing the business application. The first tool has components for entering solution parameters.

Referring to FIG. 4, IT analysts and Business users can log on the factory 2 to access the application. A security application 30 for user identification and authorization rights can be used for this purpose and to validate the user roles to enable and disable applications functions.

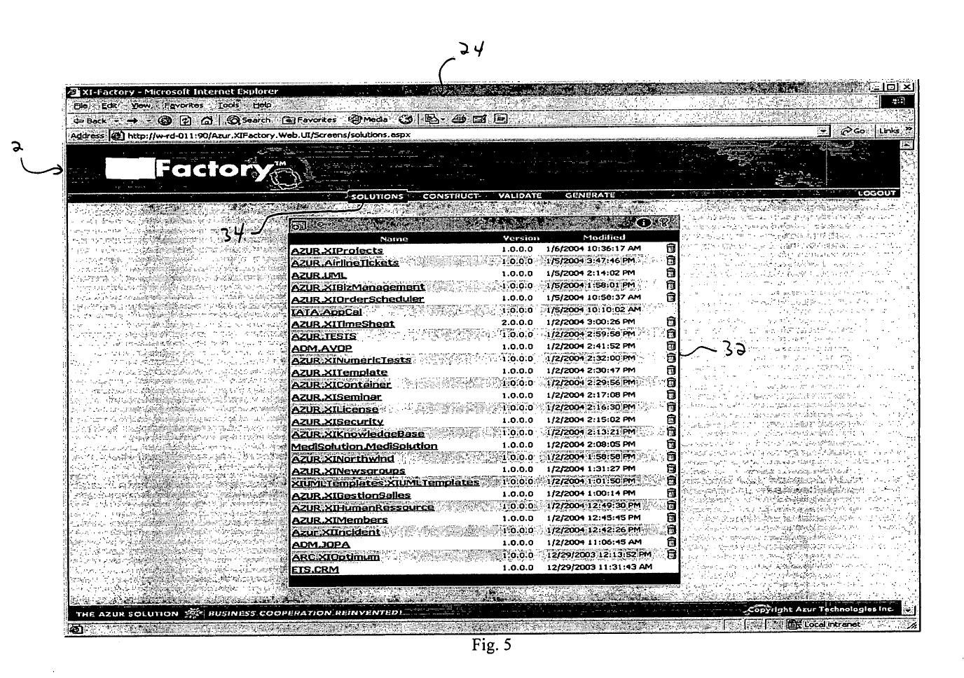

Referring to FIG. 5, once the user is authorized to access the factory application, he is redirected to a list of solutions 32 from which he can start his own project.

The first tool 34, also referred to as the Solutions section, allows managing several solutions that contain one or more e-business applications that meet the company's needs.

In this initial step, the analyst can: add and define a new solution; select an existing solution and manage the access permissions.

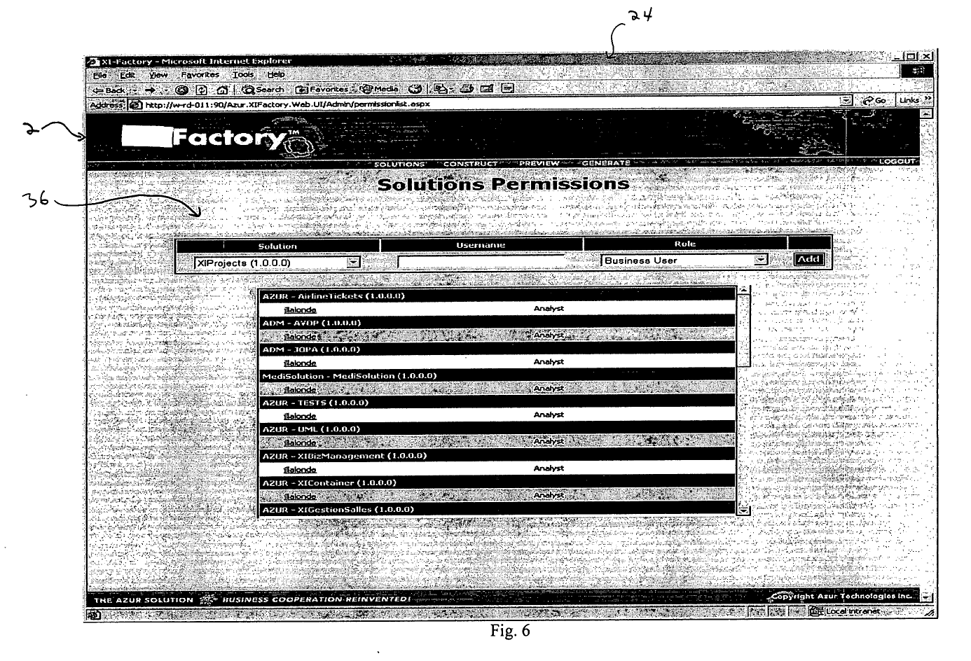

Referring to FIG. 6, within the solutions section the project analyst can manage access rights permissions 36 to allow one or several Business Users to help him validate and rectify his work.

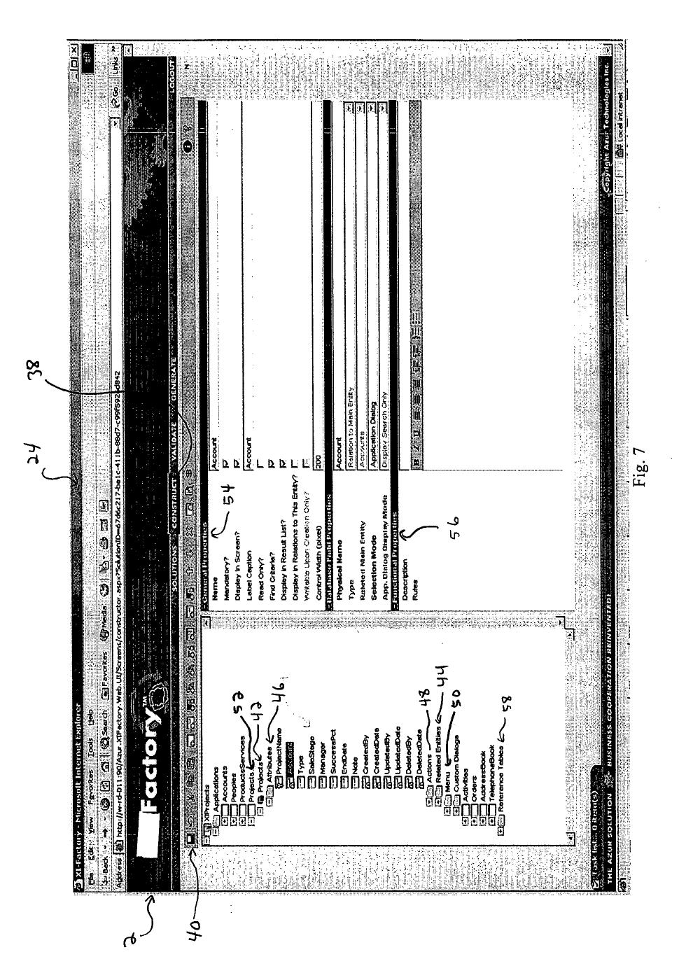

Referring to FIG. 7, the software factory 2 also has a second tool 38 also referred to as the Construct section for constructing the solution using business models in relation with the solution parameters. The second tool has components 40 for designing basic characteristics of the solution and a business domain model of the business application having a main entity 42 and related entities 44. The main entity 42 establishes relationships with the related entities 44. The main entity 42 and the related entities 44 have attributes 46 and actions 48. The second tool 38 also has components for designing a menu 50 of the business application 52, specific functions of the business application 52, and functional descriptions 56 of the business application 52.

The second tool 38 allows building one or more e-business applications 52 that belong to the same solution. The building process is very simple and operates from an expert business view. The analyst builds the application by creating a business object model:
Define the solution's basic characteristics;
Define the application;
Define the main entity;
Define the related entities;
Define the menu;
Define the reference tables;
Define the specific functions;
Define functional descriptions (business rules, data types . . . ).

In addition, this construction process is supported by Entity-Relationships modeling. One of the early problems noticed with the UML notation is that it is well adapted for detailed business modeling done by proficient IT people. However, the typical factory IT analyst may not be proficient in UML. The factory constructor web page is UML compatible while preserving as much as possible the business language.

A typical factory solution is composed of Application(s) 52 and Reference Table(s) 58:
An Application is composed of one Main Entity, Menu and Custom Dialogs:
   An entity is composed of Attributes and Actions and may have Related Entities

To construct a complete set of applications, the Constructor supports all standard Entity-Relationships model elements. The factory Constructor supports the following modeling artifacts:
Business Entity
   Attribute
   Multi-valued attribute
   Entity primary key
   Auto number primary key
   Single-field primary key
   Action
Relationships
   Weak Entity
   1:1 Relationships
   1:N Relationships
   M:N Relationships
   Multivalued Attributes
   N-ary Relationships
   ISA Relationships
   Multiple Inheritance

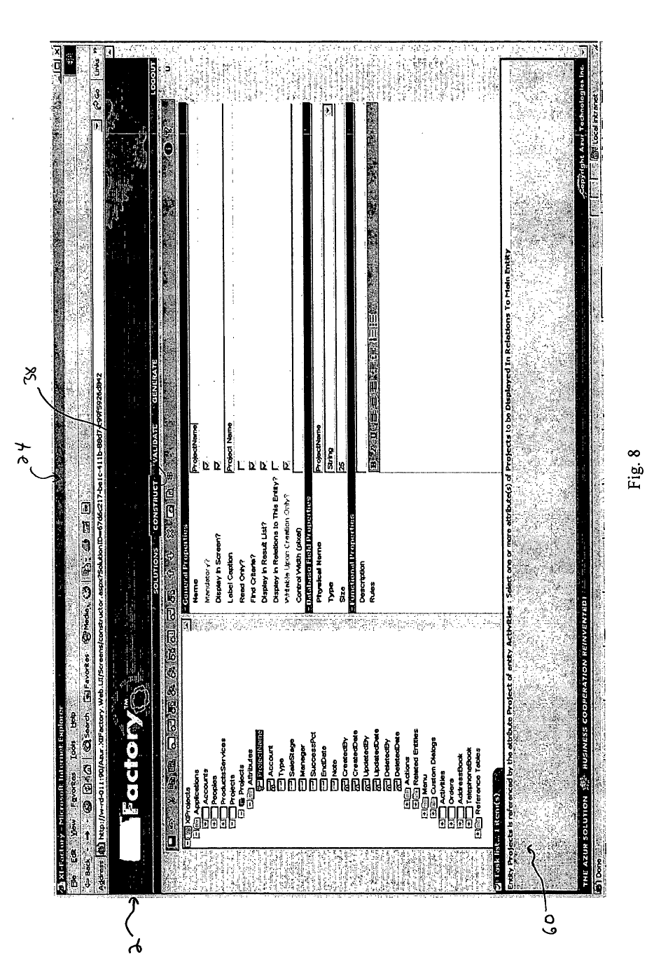

Referring to FIG. 8, whenever the analyst does illegal modeling operations, the Constructor provides a Task List 60, for him to use in order to rectify his solution.

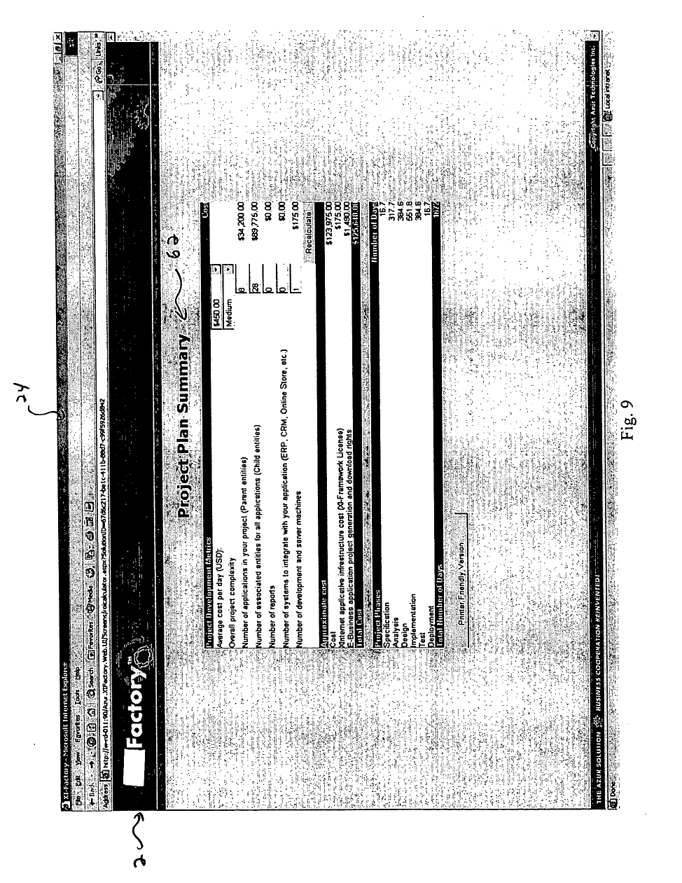

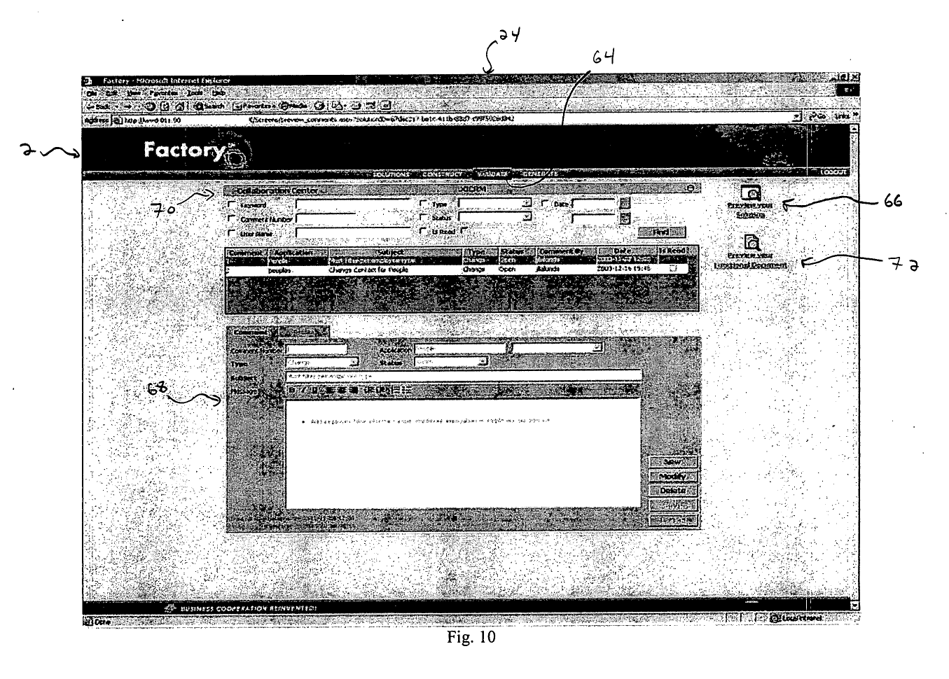

Referring to FIG. 9, the project plan summary 62 is automatically generated for the analyst to get from his project metrics the approximate project cost and duration.

Referring to FIG. 10, the software factory 2 also has a third tool 64, also referred to as the Validate section, for validating the solution. The third tool 64 has components for previewing the solution 66 by automatically generating a working prototype of the business application using dynamic database simulation means for testing the working prototype of the business application. The third tool 64 also has communication components 68 for feedback messages between users testing the working prototype of the business application and users constructing the solution.

While the solution is getting constructed, the analyst can access the third tool 64 at any time to generate the web application prototypes to test or verify his construction work. The Validate section is composed of three main elements:
Collaboration Center 70;
Preview of the e-business applications being constructed 66;
Preview of the Functional Documents 72.
   Collaboration Center 70

IT and BU personnel can easily exchange comments and replies (assisted with relevant documents) via an e-Collaboration center 70, all of which can be centralized into a single database.

Moreover, they can achieve higher level of collaboration using visual and easy-to-use e-business application prototypes, rather than the complex UML projections (more commonly used by IT teams).

An online mechanism that automatically generates, based on the business models, the e-business application operational prototypes on top of an XML document is provided. This XML document simulates, as much as possible, the application database so that the business users can experiment with the application while it is still in the analysis phase. This process also automatically generates a functional document (HTML and Word formats) with complete business information.

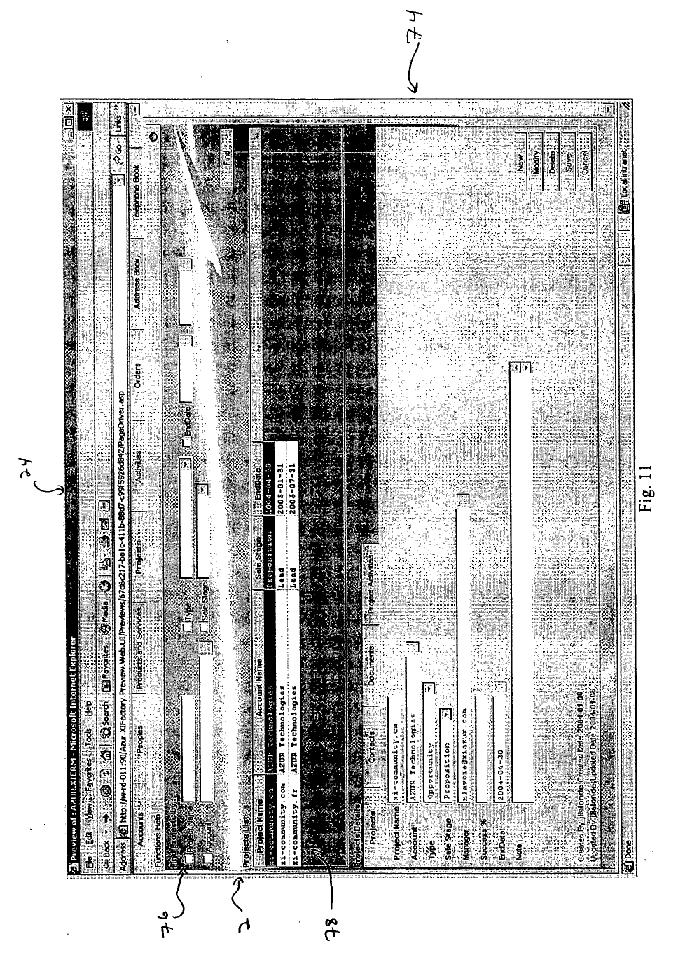

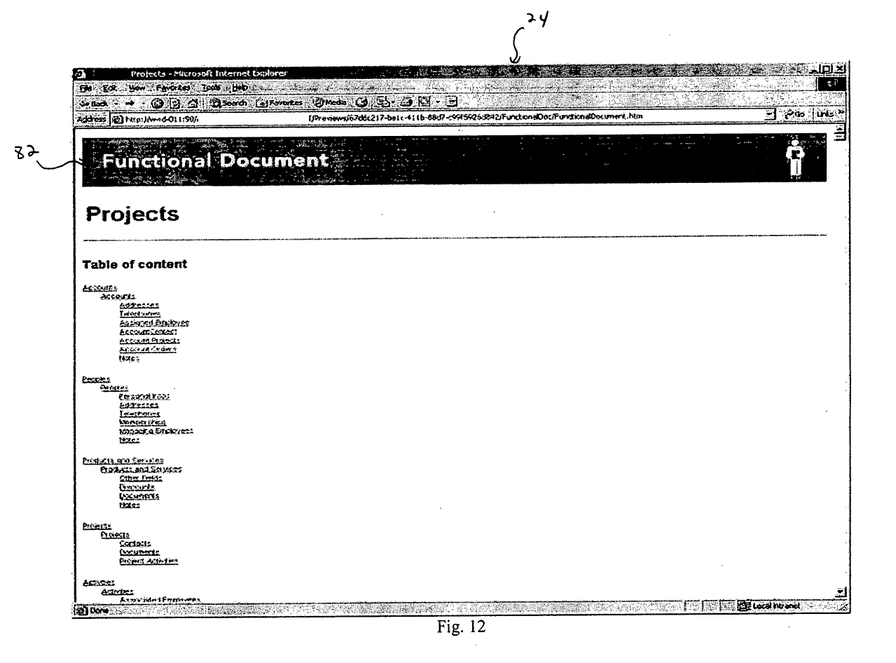

Referring to FIG. 11, the Preview allows to dynamically generate the e-business application prototypes 74 and test one or more of the applications being built.

The standard Web topology of an OWPA is made up of three different, complementary areas:
Search area with criteria 76;
Result area 78 showing one or more occurrences of the main entity;
Detail area 80 including attributes and actions supported by the main entity and its secondary entities.

The e-business page generated is made up of various JavaScript components supported by an HTML page that meets the application's needs.

The application verification process consists in testing, verifying and rectifying the following elements of the solution:
general parameters;
main and secondary entities with their respective attributes and functional descriptions;
basic functions:
Add an entity;
Modify an entity;
Delete an entity.

In addition, expert users can retroactively add comments to a distributed analysis log (Collaboration Center 70) to perfect the specifications and correct the analyst's work.

Referring to FIG. 12, the Preview allows to dynamically generate the e-business functional document 82 and validate the business rules associated to any element of the applications being built.

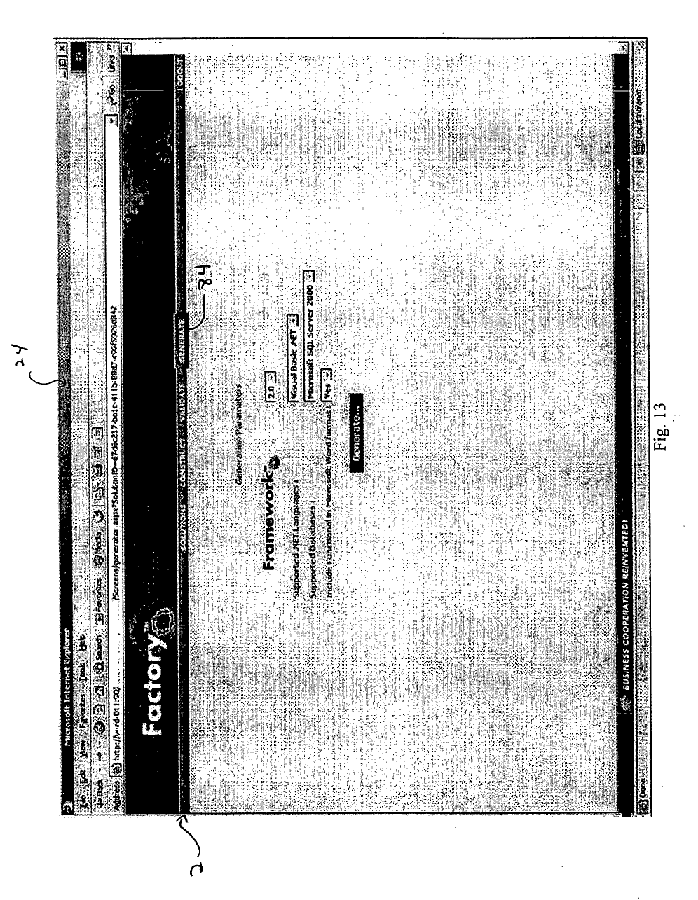

Referring to FIG. 13, the software factory 2 finally has a fourth tool 84, also referred to as the Generate section, for generating code forming an initial and operational version of the business application to be supplied as a normalized input to a regular desktop development system. After the analysis process, the analyst can access the fourth tool 84, to generate automatically the approved and operational .NET solution. The Generate section allows to generate automatically the VB or C# code for all layers of the e-business application.

This generation process also creates an installation file that one of the developers will use to deploy the .NET solution generated in his or her own VISUAL STUDIO (VS™) .NET development environment, including:
User services together with the OWPA interface;
XML Web services;
Business services;
Data access services;
SQL scripts to generate a database with generic stored procedures;
An approved functional descriptions file.

All this is supported by a standard .NET application infrastructure provided by framework and automatically included in the .NET solution. An operational .NET solution that allows performing basic operations (search, add, modify, delete) on the main and secondary entities is obtained.

To finish the e-business application, the developer can use the functional descriptions file to program the business intelligence and integrate it with the company's operational systems.

Incorporating all Levels

To successfully define, validate, and generate operational E-business applications from an MDA approach, the functional definitions of the following service levels are harmonized:
User Services;
Business Services;
Data Services;

The UML notation is well-adapted for Object-Oriented system modeling when performed by qualified IT personnel. UML is designed to accurately depict a system's layout including:
Class-Object;
Association-Link;
UseCase-UseCaseInstance;
Message-Stimulus;
and so on.

The Entity-Relationship (E-R) data model is very useful to map an Object model onto a database Relational model. In a standard Software Development Life Cycle, the application team will commonly use UML to define the application artifacts and the database designers use the E-R and Relational models to define and create the application database.

However, in current Software Engineering-State practice, UML, E-R, and Relational Models cannot efficiently demonstrate the business model requirements to the users. The general consensus is that most Business Users cannot validate a system using these models, underlying notations, and diagrams.

One way to build a useful system is to present Business Users with a working prototype of the application very early in the Software Development Life Cycle. The software factory web tool provides a unique bridge between the Object Model and the Business Model.

Just like UML and the Entity-Relationship Model help to map the object model onto the relational model, an efficient way to map the object model onto the business model is needed. The software factory 2 web tool accurately provides this type of mapping. One of the goals is to create and automatically generate e-business application operational prototypes using typical E-Business Model designs.

The typical IT business analyst may not be proficient in UML, so a design notation can be compatible with a broad set of typical IT personnel is used. The software factory 2 is based on UML, Entity-Relationship, and Relational models to create an efficient MDA bridge to .NET technologies.

Again, the software factory 2 workflow can be defined in four straightforward steps:
1. Solution:
   a. Define solution parameters
   b. Assign user access rights
2. Construction:
   a. E-Business Models
   b. Preview Project Plan Summary
3. Validation:
   a. Collaboration Center provides user and analyst feedback
   b. Preview Application Operational Prototypes
   c. Preview Application Functional Documents (in HTML format for example)
4. Generation
   a. Operational .NET Solutions with Projects, Classes and Databases Artifacts
   b. Application Functional Documents (in MS Word format for example)

Using this workflow, it is possible to construct E-Business Models and validate them from the resulting Application Operational Prototypes. These two highly complementary functions can efficiently help map the Object Model onto the Business Model, which allows Business Users to validate and customize the final product according to their requirements.

As shown in FIG. 7, the Construct web page contains the following fundamental hierarchical structural elements:
A Solution is composed of one or more Applications
An Application manages one Main (Strong) entity
A Main entity is composed of Attributes, Actions, and other related entities (optional)

The software factory 2 Construct web page can be seen as a set of web services that help define and connect Application Domain Classes (Entities). The software factory 2 Validate web page can be seen as a set of web services that help to preview and play with the Application Domain Objects.

At the software factory 2 level, the objective is not to fully support the UML or E-R detailed notations, but rather to rely on their pivotal design elements to quickly build, preview, and test business models from the business user's perspective.

The software factory 2 also has elements of the Relational model (Database Properties) to enable automatic application database generation.

Business Entity (Business Class)

A Business entity is a domain object that exists independently of other objects within a given business domain. A typical software factory application manages one central (strong) entity, which has sufficient attributes to form a primary key.

Entity Attributes

Every entity is described by a paired set of attributes (attributes, data value). For example:
(Employee.ID, 123)
(Employee.Name, John Smith)
(Employee.Email, jsmith@abc.com).

The software factory supports all standard data types.

Business Model to Object Model Mapping

The software factory automatically generate a stateless N-Tier .NET Solution with corresponding object-oriented projects and underlying domain classes. Within a .NET project, relationships between main entities (Assemblies with Classes) are realized through web services to maximize reuse.

Therefore, from within a standard Software Development Process (Unified Software Development Process (USDP), Rational Unified Process (RUP), etc.), it is possible to exercise the full UML notation richness to describe and design multifaceted domain behaviours as displayed by the business analyst in the software factory Functional Properties.

Object Model to Relation Model Mapping

The software factory Application database generation converts a Stateless Object model to a Data Model. Therefore, well-defined database tables with stored procedures are generated to remain within Relational model constraints. Within the software factory construction phase, the IT business analyst can construct a 3NF normalized business model to optimize the application code and database development phases:
1NF (First Normal Form): no multivalued attributes
2NF (Second Normal Form): no partial dependencies
3NF (Third Normal Form): avoid bad transitive dependencies
BCNF (Boyce-Codd Normal Form): strengthens 3NF
   Applicative Framework System

The solution also comprises the applicative framework system 4 supplying a generic dynamically adaptable N-Tier client-server object-oriented applicative infrastructure constructed on top of a third party software system infrastructure to support a business application compatible with XInternet technologies via a communication network. The third party software system infrastructure is complemented by database management system components.

The applicative framework system 4 makes available to enterprises a highly flexible N-tier client-server applicative infrastructure, which can respond to client business needs with respect to collecting, processing, integrating and sharing data on extended networks.

The applicative framework system can be upgraded to MICROSOFT .NET technologies to supply an efficient fabrication solution for the emerging XML Web Services applications and system integrations. MICROSOFT .NET framework gives the building blocks reused for each of the N-Tier architecture components and system integrations.

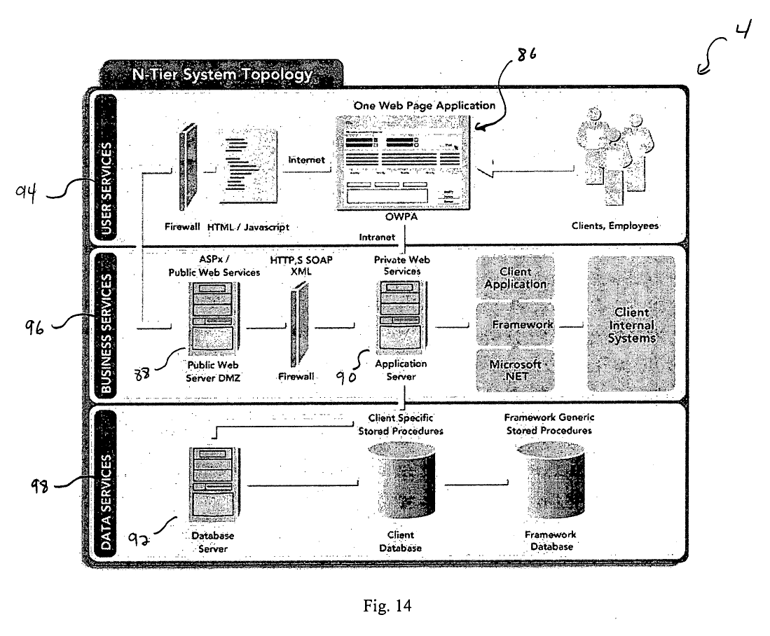

Referring to FIG. 14, the applicative framework system 4 comprises an applicative framework having generic adaptable software structures for the creation of the business application 86 on any specific technology platform using a web server 88, a business server 90 and a database server 92, all connectable to the communication network, on which the business application 86 is fabricated, developed, tested and deployed.

The applicative framework system 4 is a resourceful solution for quick project start-up and professional fabrication of transactional intranet/Internet e-business applications. Such applications are very difficult to build. They require a high level of skill and expertise. Moreover, for a company to build its own N-Tier system software infrastructure would require at least a year of sustained R&D efforts with an experienced team, assuming they would even succeed. In most cases, the cost of building an efficient and complete N-Tier framework cannot be justified. The applicative framework system is a set of tools, components, system integrations, sample codes and documentation all available at a fraction of the development costs. The applicative framework system is a complete package covering three specific N-Tier architecture requirements: User services 94, Business services 96 and Data services 98.

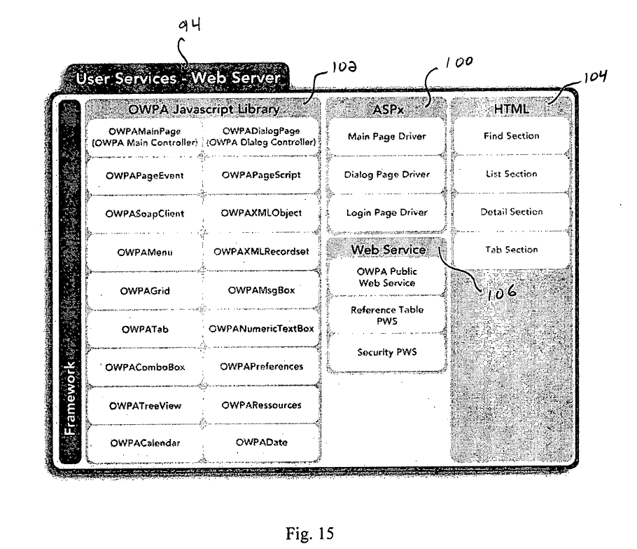

Referring to FIG. 15, the applicative framework also has user services 94 for managing a business application user interface, relying on a XInternet one web page application pattern, on a workstation having a browser interface 24 to access the business application 86 from the web server 88 on which business application web services are deployed. The business application user interface is a dynamic web page avoiding web page transitions for user experience. The user services have one web page application components library for displaying the business application user interface on the browser interface and for communicating between the business application user interface displayed in the browser interface 24 and the business application web services deployed on the web server 88. The one web page application (OWPA) components library provides bi-directional communications between the workstation and the web server 88. This OWPA library can be composed of a comprehensive set of JavaScript components, HTML files, ASPx files and Web services.

Significant User Services 94 are best provided and managed by a set of essential client-side components structured together as an OWPA. An OWPA is essentially a dynamic Web page, residing at a unique URL (Uniform Resource Locator), providing extremely secure high-speed SOAP/XML (Simple Object Access Protocol/Extensible Markup Language) calls to the Web server 88. The OWPA is easily accessed simultaneously from both Internet and intranet networks that provide proper user credentials and application access role rights. To build an OWPA, as shown below, HTML and JavaScript technologies are used. A complete library of JavaScript components is used to better harness the processing power of client workstations.

For example, as shown in FIG. 15, the following technology integrations is required to communicate securely with the Web Server:
The Web server, running IIS, receives calls from an IE browser for the OWPA ASPx Main Page Driver.
The Page Driver packages the required HTML and JavaScript files and returns them to the user's browser.
The user OWPA is constructed on the workstation:
   HTML and JavaScript structures are constructed;
   ComboBoxes are filled by initial HTTP,S/SOAP/XML calls to the Reference Table Public Web Service.
Once the user selects an action, the proper OWPA Web Service method is called. Every call can be validated by the Security component before being processed by the application.

OWPA ASPx Page Descriptions

ASPx Pages 100

| | |
|---|---|
| OWPAMain | ASPx file used to return the HTML and JavaScript |
| PageDriver | files required from the Web Server to build OWPA |
| | main page. |
| OWPADialog | ASPx files used to return the HTML and JavaScript |
| PageDrivers | files required from the Web Server to build the |
| | OWPA child dialog pages. |
| LoginPages | Web server ASPx files manage user login with the |
| | following functions: |
| | Access denied |
| | Change password |
| | Forgot password |
| | Password expired |

OWPA JavaScript Component Descriptions

JavaScript Components 102

| | |
|---|---|
| OWPAPageEvent | Initially, used to build the OWPA during start-up. |
| | Subsequently manages all specific events produced |
| | by the user. Each time a user selects an OWPA- |
| | specific action; the call is intercepted by this |
| | central component and redirected to the proper |
| | OWPA Webservice function. |
| OWPA | Heart of the OWPA. It is holding all application |
| MainPage | information. Initialized on application start-up. |
| | Automatically manages application generic |
| | actions, fields and states. |
| OWPA | Heart of OWPA dialog screens. Holds all dialog |
| DialogPage | information. Initialized at the start of the |
| | dialog. |
| | Automatically manages dialog generic actions, |
| | fields and states. |
| OWPAPageScript | Holds specific or user-defined application |
| | functions that cannot be generalized into the |
| | OWPAMainPage component. |
| OWPAMenu | Builds and manages the OWPA toolbar menu. Used |
| | to get access to user preferences, reports and |
| | specific functions. |
| OWPAGrid | Builds and manages the OWPA parent and child |
| | object lists. This grid has all standard |
| | functions (sorting, resizing, etc.) of an |
| | equivalent ActiveX grid, but without browser |
| | installation and usage security problems. |
| | The client browser will accept this fully |
| | JavaScript grid without any security warning. |
| | The grid is completely secure and installs |
| | itself automatically within the application. |
| OWPATabControl | Houses and manages OWPA parent and child object |
| | properties (1-1) or lists (1-n). A great deal of |
| | information is thus accessible quickly with a |
| | single mouse click. |
| OWPAComboBox | OWPA reference table data loaded at application |
| | start-up. |
| | This intelligent ComboBox can detect and handle |
| | deleted and out-of-date values. |
| OWPATreeview | OWPA tree information, such as application user |
| | roles. |
| | This fully JavaScript component enables the |
| | developer to build complex Web application |
| | requiring multidimensional or hierarchical |
| | structures. |
| OWPACalendar | Helps user select a valid date. |
| OWPADateControl | Ensures proper date value format. |
| OWPANumeric | Ensures proper numeric value format. |
| TextBox | |
| OWPAMsgbox | Used to format and display application |
| | messages to the user. |
| OWPAPreferences | Manages user preferences, such as preferred |
| | language and application parameters. |
| OWPAResources | Manages application resources such as user |
| | warnings, errors or information messages. |
| OWPASOAPClient | Manages application SOAP calls to the Web |
| | Services running on the Web servers. |
| OWPAXMLObject | Manages application XML documents used to call |
| | for and exchange data with the Web Servers |
| | through SOAP calls. |
| OWPAXML | Transforms an XML document into a recordset |
| Recordset | structure whenever required by a developer to |
| | ease data manipulation at the client side. |

OWPA HTML Page Descriptions

HTML Pages 104

| | |
|---|---|
| FindSection | Holds JavaScript components and builds OWPA Find |
| | section. |
| ListSection | Holds JavaScript components and builds OWPA |
| | result or object List section. |
| DetailSection | Holds JavaScript components and builds OWPA Detail |
| | section. |
| TabSections | Hold JavaScript components, main and related |
| | object properties, and lists. |

OWPA Web Service Descriptions

Web Services 106

| | |
|---|---|
| OWPAPublic | These Web Service interface methods were built to |
| WebService | isolate client code from server code (Facade Pattern). |
| | Holds generic methods required to access and manage |
| | most of the application functions and data. |
| Security | Holds generic methods required to access and manage |
| WebService | user security credentials and application access |
| | rights and roles. |
| | Any call made by an OWPA to a Web Server is |
| | first validated with the Security Web Service to |
| | ensure the user has the authority to access that |
| | server function. |
| | There are two types of Security Web Services: |
| | 1. Public: Web Service for access validation from |
| | any OWPA. |
| | 2. Private: Web Service for read/write access from |
| | a user Security administrative OWPA business task, |
| | as shown below. |
| ReferenceData | Holds generic methods required to access and manage |
| WebService | the reference table's data used to populate OWPA |
| | combo boxes. With this Web Service, we are able to |
| | manage reference tables with associated generic and |
| | specific relational data models. |
| | There are two types of Reference Data Web Services: |
| | 1. Public: Web Service for read access from any OWPA. |
| | 2. Private: Web Service for read/write access from a |
| | Reference Table administrative OWPA business task. |

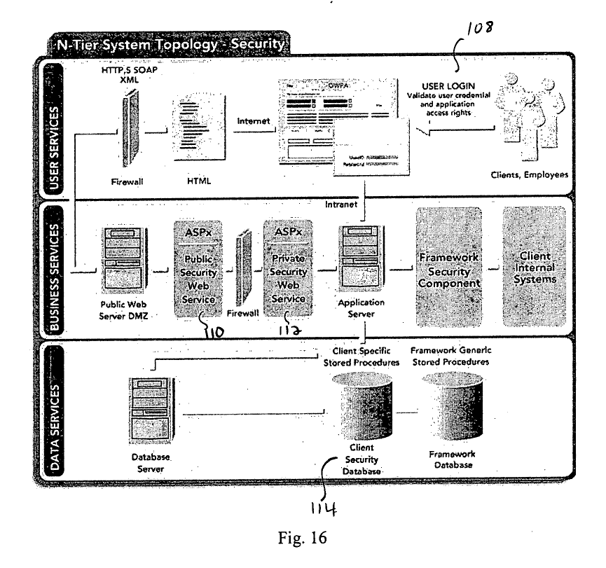

Referring to FIG. 16, to securely access an OWPA, the user provides the proper credentials, as described below:
User accesses company application Web login page 108 from Internet (or intranet).
User enters ID and password.
Public Security Web Service 110 receives the call and proceeds with validation.
Intranet private Web Service 112 asks a Security object for user validation. The client security database 114 contains user credentials and application access rights.
With proper identification, user gains access to the application within predefined restrictions associated with his/her role (manager, clerk, etc.).

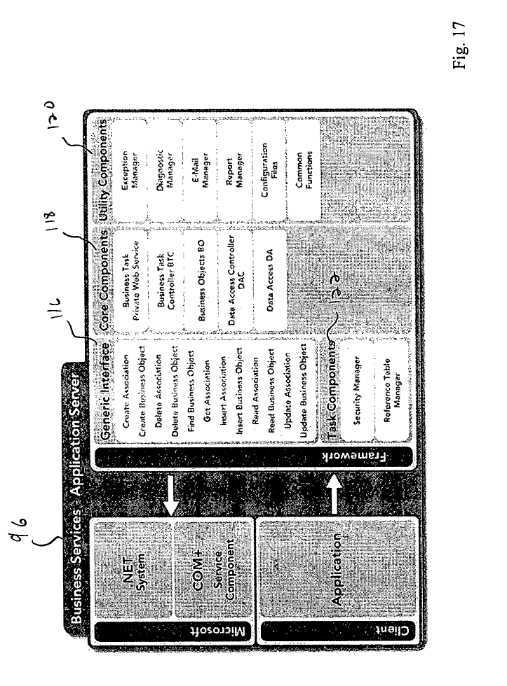

Referring to FIG. 17, still, the applicative framework also has business services 96 for managing business application logic and communications between the business application web services. The business services are implemented on the business server 90, the applicative framework and system components of the third party software system infrastructure. The business services have generic adaptable components having interface application components 116, core application components 118, utility application components 120 and task application components 122 being used to insure code reusability, adaptability, uniformity, isolation, stability, robustness, scalability and performance. The Business services 96 are build from several architectural server assemblies (.NET Components).

A specific client application is thus constructed from inherited framework components through standard Namespaces. The portion of inherited application server code can amount to up to 70% for a normal business task. The remaining 30% is associated to client-specific business rules. framework makes effective use of MICROSOFT .NET system services and the COM+ service component for high system security, performance, stability and scalability.

A generic interface used to isolate each level of service (User Services 94, Business Services 96 and Data Services 98). Any components involved in the communication chain—OWPA interface, Web services, application components and database-stored procedures—employ this interface to assure code reusability and system stability. Based on user requirements, business rules for a given client application can be applied at any system level to specify the chain of communication.

Generic Interface Methods 116

| | |
|---|---|
| Create Association | Create a new initialized an associated object. |
| Create Business | Create a new initialized main object. |
| Object | |
| Delete Association | Delete an associated object. |
| Delete Business | Delete a main object. |
| Object | |
| Find Business Object | Find a list of main object. |
| Get Association | Get a parent object's associated objects. |
| Insert Association | Insert a new associated object. |
| Insert Business Object | Insert a new main object. |
| Read Association | Read a main object's associated object. |
| Read Business Object | Read a main object. |
| Update Association | Update a main object's associated object. |
| Update Business | Update a main object. |
| Object | |

Framework Core Component Descriptions

Core Components 118

| | |
|---|---|
| Business Task | Accesses the application Business Task |
| Private Web Service | Controller through secure HTTP, S, SOAP/XML |
| | calls. Also filters unauthorized calls via |
| | the security component. |
| Business Task | Manages the application workflow and handles |
| Controller (BTC) | architectural aspects such as two-phases |
| | commit transaction management, error |
| | management and diagnostic management. |
| Business Object (BO) | Implements application business rules. |
| DataAccessController | Manages data services workflow and handles |
| (DAC) | specific database transactions. |
| DataAccess (DA) | Implements database connections and links |
| | to stored procedures with parameters. |

Framework Utility Component Descriptions

Utility Components 120

| | |
|---|---|
| Exception Manager | Used by Business Task Controller to handle all |
| | system or application warnings and errors. |
| Diagnostic Manager | Used by Business Task Controller for |
| | application diagnostic and error recovery. |
| E-mail Manager | Used by Business Task Controller or Business |
| | Object to handle electronic communications. |
| Report Manager | Used by Business Task Controller or Business |
| | Object to produce canned or predefined user |
| | reports. |
| Configuration files | Replaces old registry settings such as |
| | application paths and database connections. |
| Common Functions | A battery of handy reusable generic functions. |

Framework Task Component Descriptions

Task Components 122

| | |
|---|---|
| Security Manager | Used by intranet Private Web Service for user |
| | credential and application access right validations. |
| | Any call made to the Business Task Controller is |
| | thus subject to prior validation and approval to |
| | prevent security breaches. |
| | Also used by system administrator through an |
| | administrative Security OWPA to manage user |
| | credentials and application role access rights. |
| Reference Data | Used to fill OWPA combo boxes or pick lists. |
| Manager | Supports generic or specific Reference table data |
| | models. Also used by system administrator through |
| | an administrative Reference Table OWPA to manage |
| | system reference tables and data. |

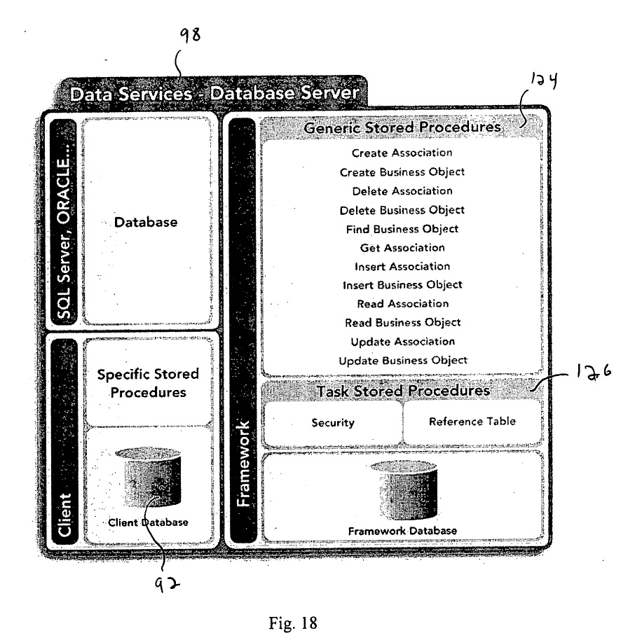

Referring to FIG. 18, the applicative framework finally has data services 98 for managing business application data access logic and communications between the business services and the third party database management system components on the database server upon request of the business server on which the business services are implemented. The data services comprise generic adaptable database access components 124 having database scripts to automatically assist the creation of application database tables and stored procedures 126 required to access and manage application data on the database server 92.

These generic stored procedures 126 are reused and specified to the client domain of expertise. The framework makes use of the SQL Server™ and Oracle™ database functions to achieve and ensure high system security, performance, stability and scalability.

Database Services

| | |
|---|---|
| Framework | Framework and System data. |
| Database | |
| Generic Stored | Ultimately implemented as generic and reusable stored |
| Procedures | procedures for application main and associated objects |
| | management. |
| Task Stored | Incorporates security and reference table and data |
| Procedures | management through specific Task Stored Procedures. |

The framework is easy to use in the application code. Once it is installed in the developer environment, the developer can use the framework client components library to build the application user services and the framework server components library to build the application business and data services. The following diagram illustrates the high-level structures required to build and execute a One Web Page Application.

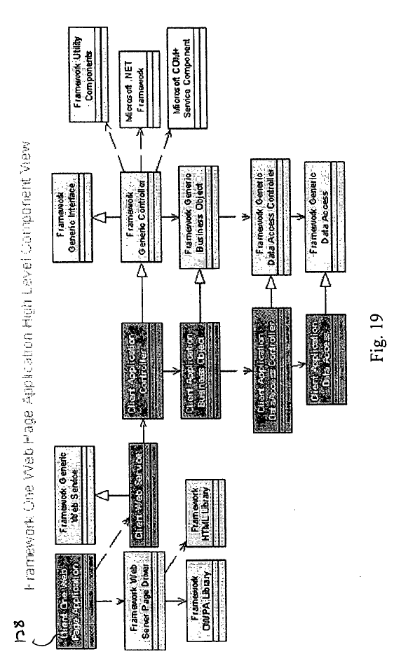

Referring to FIG. 19, the Client One Web Page Application 128 is initially constructed from the Web Server Page Driver (ASPx file) composed of HTML pages holding OWPA JavaScript components. Once the Client OWPA is constructed into the browser, the user can start using it. Every SOAP call made to the server side is handled through a Web Service connected via HTTP/S accessing the Client Application Controller. The client Application inherits the generic behaviour of the framework stateless components. The client Application is also supported by the framework utility components and the MICROSOFT .NET and COM+™ system infrastructures.

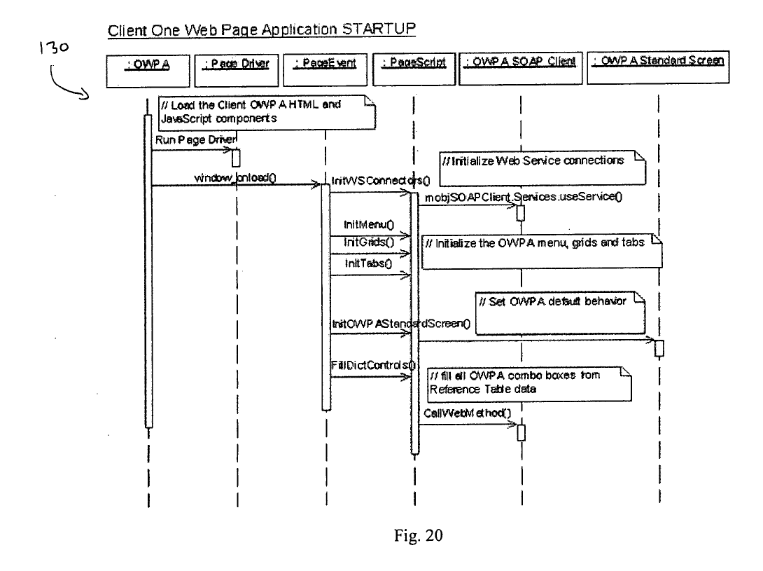

Referring to FIGS. 20 to 22, there are shown complete IBM Rational Rose™ Sequence diagrams 130, 132, 134 with all the steps required to understand how to generate a call through all level of services of the framework N-Tier software infrastructure.

In FIG. 20, there is shown a sequence diagram 130 of the interaction between framework and the client application own structures build into the Internet Explorer browser the client One Web Page Application.

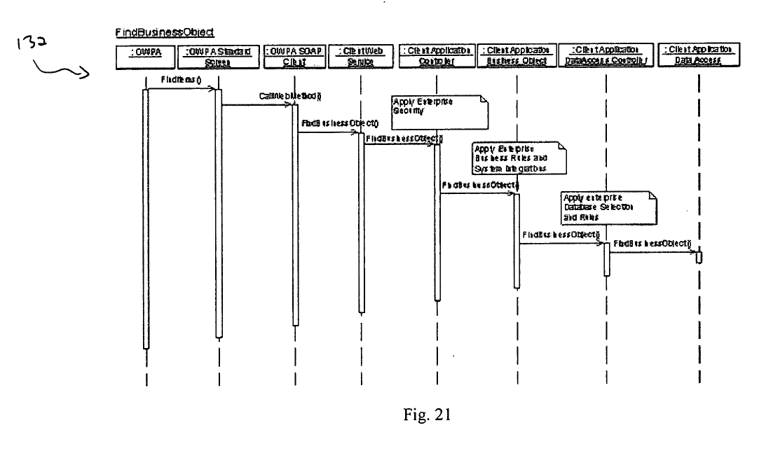

In FIG. 21, there is shown a sequence diagram 132 of the interaction between framework and the client application own structures to make the Find Business Object call.

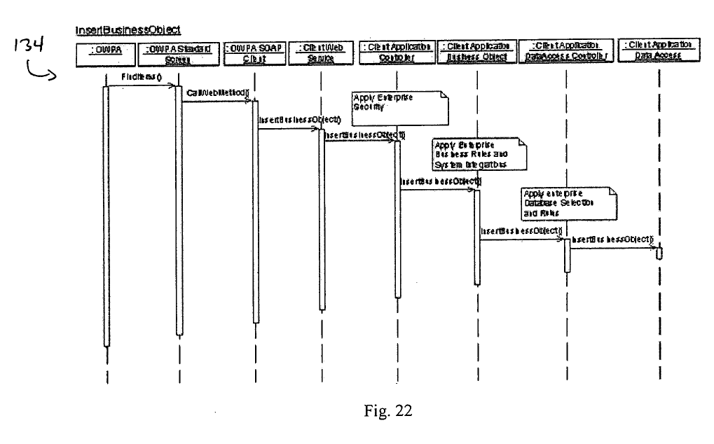

In FIG. 22, there is shown a sequence diagram 134 of the interaction between framework and the client application own structures to make the Insert Business Object call.

Community

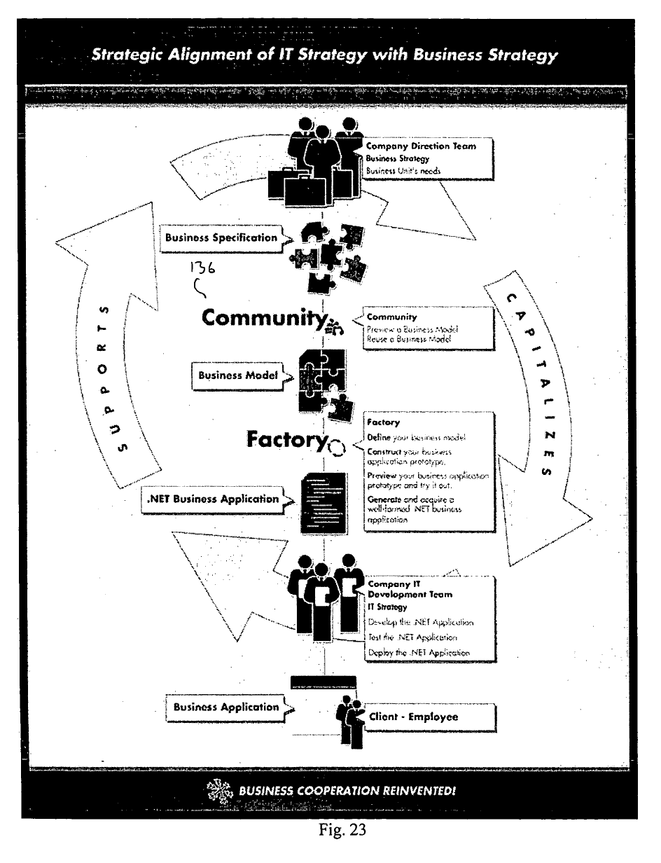

As shown in FIG. 23, preferably, the solution can be accessible through a web community 136. The community can be deployed at a large Telecom Application Service Provider for IT partners, departments, solutions providers and consultants, for example using MICROSOFT .NET technologies, who want to quickly publish efficient e-business applications to the web.

For example, a strategic alliance with a large Telecom partner and MICROSOFT to put in place a high visibility web community for the IT and business people can be made to better collaborate over the web.

MICROSOFT .NET technologies are used to develop dynamic web applications based on web services. However, the increasing level of complexity of these types of applications is prohibiting it to grow at the predicted rate. From the knowledge of the current market situation, the following problems were noticed:
1. High rate of failure for e-business application development based on web services prohibiting Ei and B2Bi to grow at the predicted rate;
2. Development high costs and time not accessible for mid-market and small companies;
3. Development level of complexity is much too high;
4. .NET slower rate of acceptance among Canadian market; and
5. Divergence among IT and Business people strategic goals.

To overcome these problems, it is possible to create the Community to provide to the IT and Business communities a web tool that optimizes the collaboration between them in order to better achieve enterprise integration, business-to-business integration and also the people integration. This unique IT and business community can be driven by different companies each bringing to the table their core business to lower, as much as possible, the cost of deploying such an important web based capacity.

The Community can be especially designed for MICROSOFT partner's to improve their ability to execute .NET projects far better than their Java and Linux counterparts. This project has the potential to radically change the way .NET Web Services Applications are getting build all over the world.

The Web Services Application Development economic model will be impacted greatly. While reducing .NET project development costs and time, it will generate faster market acceptance for web services thus generating more projects and revenues for participating partners. The Community can be perceived as offering a set of sophisticated and reusable Web Services designed for the Web Services Applications Development arena. Community has the potential to become a very efficient Lead Generator for partners to profit from:
Application development services;
Infrastructure;
Training services;
Application hosting;
Advertising;
solution provider;

To build and promote the community, an e-business community founded on sharable and reusable XInternet business models, applications and software from which any partners using the community unique e-Software Fabrication Process emerge prepared to better and quicker achieve enterprise, business to business and people integration projects at reasonable costs.

The community portal is envisioned for IT and Business people to better collaborate over the web to achieve mutual strategic alignment. At its core, the community offers a unique XInternet application (the factory) that helps people quickly and efficiently build profitable XInternet applications targeted to the MICROSOFT .NET Platform.

Distinctively, it offers a set of clever web services, which value Ei, B2Bi and Pi through an innovative web-based e-Software Fabrication Process (e-SFP) usable form any place, any path, any pace at any time.

The community can serve as a new tool to promote business strategic alignment or the alignment of information systems strategy with business strategy as it continues to be ranked as one of the most important issues facing corporations.

It features a unique e-collaborative environment for the Business Users to quickly validate and rectify the IT analyst software prototypes, business process and tasks and rules assumptions.

For example, for a small membership fee, the community can propose the following project Go/No Go type of workflow:
1. Reuse community business models or start their own from scratch.
2. Quickly and very easily fabricate (within hours) a working prototype of your e-business application without manual coding,
3. Invite expert users to try the operational web prototype; for them to get a feel for how it will behave and confirm that this is what they need or not.

Afterward, when the project receives a Go, the partner can generate a well-formed .NET solution of the application. Then developers use the framework, on top of the .NET framework, to rapidly build, within VISUAL STUDIO.NET, scalable, robust and profitable XInternet applications to its clients.

An average project could end up managing more than 100 database relational tables. The generated well-formed N-Tier .NET solution may represent 40% to 75% of the final application code. This .NET code is automatically generated right after the analysis phase by the web tool thus producing a ROI which is very easy to justify and to demonstrate.

The community can also serve as a new web tool to converge and amalgam partner's products and services within a structured and complete client offer for:
Development services;
Training services;
Application help services;
Hosting services;
Complementary solution provider;
Advertising for:
   Services;
   Training;
   Components;
   solution Providers;
   Hosting;
Infrastructure:
   Windows 2003™ from MICROSOFT
   SQLServer™ from MICROSOFT
   BizTalk Server™ from MICROSOFT
   Workstations, servers machine, . . .

While embodiments of this invention have been illustrated in the accompanying drawings and described above, it will be evident to those skilled in the art that changes and modifications may be made therein without departing from the essence of this invention.

1. A distributed fabrication system for creating, while promoting strategic alignment between information technology departments and business units' objectives, a business application compatible with XInternet technologies via a communication network, the fabrication system comprising:
a client workstation connectable to the communication network, the workstation having a browser interface;
a software factory displayed in the browser interface through which a user fabricates the business application in response to business need specifications, the software factory being displayed in the browser interface from factory building files, the software factory comprising:
a first tool for defining a solution containing the business application, the first tool comprising components for entering solution parameters;
a second tool for constructing the solution using business models in relation with the solution parameters, the second tool comprising components for designing basic characteristics of the solution and a business domain model of the business application having a main entity and related entities, the main entity establishing relationships with the related entities, the main entity and the related entities having attributes and actions, the second tool also comprising components for designing a menu of the business application, specific functions of the business application, and functional descriptions of the business application;
a third tool for validating the solution, the third tool comprising components for previewing the solution by automatically generating a working prototype of the business application using dynamic database simulation means for testing the working prototype of the business application and communication components for feedback messages between users testing the working prototype of the business application and users constructing the solution; and
a fourth tool for generating code forming an initial and operational version of the business application to be supplied as a normalized input to a regular desktop development system; and
a web server connectable to the communication network, the web server providing the factory building files and controlling the software factory displayed in the browser interface of the workstation.

2. The distributed fabrication system according to claim 1, wherein the first, the second, the third and the fourth tools of the software factory use a business model to assist with creation of the business application to isolate business application definitions from implementation of the business application on any specific technology platform.

3. The distributed fabrication system according to claim 1, wherein the first tool further comprises importing means for importing a business object and data model for constructing the solution and to design the basic characteristics of the solution, the application business domain model, the application specific functions, and the application functional descriptions.

4. The distributed fabrication system according to claim 1, wherein the code forming the business application comprises an applicative framework supplying a generic dynamically adaptable N-Tier client-server object-oriented applicative infrastructure constructed on top of a third party software system infrastructure to support the business application, the third party software system infrastructure being complemented by database management system components.

5. The distributed fabrication system according to claim 4, wherein the applicative framework comprises generic adaptable software structures for the creation of the business application on any specific technology platform using a web server, a business server and a database server on which the business application is fabricated, developed, tested and deployed, the applicative framework also comprising:
user services for managing a business application user interface, relying on a XInternet one web page application pattern, on a workstation having a browser interface to access the business application from the web server on which business application web services are deployed, the business application user interface being a dynamic web page avoiding web page transitions for user experience, the user services comprising one web page application components library for displaying the business application user interface on said browser interface and for communicating between the business application user interface displayed in said browser interface and the business application web services deployed on the web server, the one web page application components library providing bi-directional communications between said workstation and said web server;
business services for managing business application logic and communications between the business application web services, the applicative framework and the third party software system infrastructure, the business services being implemented on the business server, the business services comprising generic adaptable components having interface application components, core application components, utility application components and task application components, the generic components being used to insure code reusability, adaptability, uniformity, isolation, stability, robustness, scalability and performance; and
data services for managing business application data access logic and communications between the business services and the third party database management system components on the database server upon request of the business server on which the business services are implemented, the data services comprising generic adaptable database access components having database scripts to automatically assist the creation of application database tables and stored procedures required to access and manage application data on the database server.

6. The distributed fabrication system according to claim 5, wherein the code generated by the fourth tool comprise an approved, operational and well-formed solution comprising the applicative framework specified from business application definitions to be supplied as a normalized input to a regular desktop development system.

7. The distributed fabrication system according to claim 1, wherein the first tool also comprises security components to define security for business users and information technology experts access rights and roles to the solution.

8. The distributed fabrication system according to claim 1, wherein the second tool comprises web services to define and connect application domain entities and the third tool comprises web services to preview, test, validate and interact with application domain objects and object links.

9. The distributed fabrication system according to claim 8, wherein the dynamic database simulation means for testing the working prototype of the business application comprise an XML document simulating an application database, the XML document being used to add, delete and modify the application domain objects and object links.

10. The distributed fabrication system according to claim 1, wherein the database simulation means for testing the working prototype of the business application comprise object operation means for adding objects in a simulated database, modifying the objects in the simulated database, deleting the objects from the simulated database and finding, adding, modifying and deleting links between the objects, the object operation means being used for testing the main entity objects of the application, the related-entities objects of the application, the menu of the application, the specific functions of the application and the functional descriptions of the application.

11. The distributed fabrication system according to claim 1,
further comprising a database server connectable to the communication network,
wherein the communication components for feedback messages between the users testing the working prototype of the business application and the user constructing the solution comprise collaborative functions means for providing a collaboration center with the feedback messages centralized on the database server.

12. The distributed fabrication system according to claim 1, wherein the factory building files are selected from a group consisting of HTML files, ASPx files, DHTML components files, programs files, assemblies files, components files, XML Documents files and Web Services files accessed from HTTP,S and SOAP protocols.

13. The distributed fabrication system according to claim 1, wherein the third tool further comprises components for automatically generating a functional document of the solution.

14. The distributed fabrication system according to claim 1, wherein the solution comprises a plurality of the business application.

15. The distributed fabrication system according to claim 1, wherein the testing of the working prototype of the business application allows to determine a state of operability and profitability of the solution by following a project go/no go type workflow to reduce cost and time for project approval.

16. An applicative framework system supplying a generic dynamically adaptable N-Tier client-server object-oriented applicative infrastructure constructed on top of a third party software system infrastructure to support a business application compatible with XInternet technologies via a communication network, the third party software system infrastructure being complemented by database management system components, the applicative framework system comprising:
a client workstation connectable to the communication network, the workstation having a browser interface;
a web server connectable to the communication network;
a business server connectable to the communication network;
a database server connectable to the communication network; and
an applicative framework comprising generic adaptable software structures for the creation of the business application on any specific technology platform using the web server, the business server and the database server on which the business application is fabricated, developed, tested and deployed, the applicative framework also comprising:
user services for managing a business application user interface, relying on a XInternet one web page application pattern, on a workstation having a browser interface to access the business application from the web server on which business application web services are deployed, the business application user interface being a dynamic web page avoiding web page transitions for user experience, the user services comprising one web page application components library for displaying the business application user interface on said browser interface and for communicating between the business application user interface displayed in said browser interface and the business application web services deployed on the web server, the one web page application components library providing bi-directional communications between said workstation and said web server;
business services for managing business application logic and communications between the business application web services, the business services being implemented on the business server, the applicative framework and system components of the third party software system infrastructure, the business services comprising generic adaptable components having interface application components, core application components, utility application components and task application components being used to insure code reusability, adaptability, uniformity, isolation, stability, robustness, scalability and performance; and
data services for managing business application data access logic and communications between the business services and the third party database management system components on the database server upon request of the business server on which the business services are implemented, the data services comprising generic adaptable database access components having database scripts to automatically assist the creation of application database tables and stored procedures required to access and manage application data on the database server.

17. The applicative framework system according to claim 16, wherein the third party software system infrastructure comprises a MICROSOFT .NET framework and COM+ service components.

18. The applicative framework system according to claim 16, wherein the interface application components comprise function means for performing the following operations to help create a normalized data model:
creating, inserting, updating and deleting main objects;
creating, inserting, updating and deleting main object related objects;
creating, inserting, updating and deleting main object links to the related objects;
finding a list of the main objects;
selecting in the list one of the main objects;
creating, inserting, updating and deleting main object operations;
creating, inserting, updating and deleting main object related object operations;
creating, inserting, updating and deleting object de-normalized views; and
creating, inserting, updating and deleting application menus.

19. The applicative framework system according to claim 16, wherein the core application components comprise function means for performing the following operations:
managing business application workflow and handling business application architectural aspects, the architectural aspects transaction management, error management and diagnostic management;
implementing business application tasks and rules;
managing data services workflow and handling specific database transactions; and
implementing database connections.

20. The applicative framework system according to claim 16, wherein the utility application components comprise an exception manager to manage warnings and errors, a diagnostic manager to diagnose the business application and to recover from errors, an email manager to handle electronic communications, a report manager to produce reports, configuration files to replace old registry settings, and common functions means to provide basic reusable functions.

21. The applicative framework system according to claim 16, wherein the task application components comprise a security manager to manage access rights validations to the business application and a reference data manager supporting generic or specific reference table data models.

22. A distributed software fabrication process for creating, while promoting strategic alignment between information technologies departments and business units objectives, a business application compatible with XInternet technologies via a communication network, the software fabrication process comprising the steps of:
displaying a software factory through a browser interface of a client workstation connectable to the communication network, the software factory allowing a user to fabricate the business application in response to business need specifications, the software factory being displayed in the browser interface from factory building files;
providing the factory building files from a web server to the client workstation and controlling the software factory displayed in the browser interface of the client workstation;
defining a solution containing the business application via the software factory, the software factory comprising a first tool having components for entering solution parameters;
constructing the solution using business models in relation with the solution parameters via the software factory, the software factory comprising a second tool having components for designing basic characteristics of the solution and a business domain model of the business application having a main entity and related entities, the main entity establishing relationships with the related entities, the main entity and the related entities having attributes and actions, the second tool also comprising components for designing a menu of the business application, specific functions of the business application, and functional descriptions of the business application;
validating the solution via the software factory, the software factory comprising a third tool having components for previewing the solution by automatically generating a working prototype of the business application using dynamic database simulation means for testing the working prototype of the business application and communication components for feedback messages between users testing the working prototype of the business application and users constructing the solution;
determining a state of operability and profitability of the solution by following a project go/no go type workflow to reduce cost and time for project definition and approval and to improve strategic alignment between information technologies and business units objectives; and
generating code via the software factory to form an initial and operational version of the business application to be supplied as a normalized input to a regular desktop development system, the code forming the business application comprising an applicative framework supplying a generic dynamically adaptable N-Tier client-server object-oriented applicative infrastructure constructed on top of a third party software system infrastructure to support the business application on any specific technology platform.

23. The distributed fabrication system according to claim 1, wherein the browser interface is a container controller.

24. The applicative framework system according to claim 16, wherein the browser interface is a container controller.

25. A distributed software fabrication process according to claim 22, wherein the browser interface is a container controller.
